(19) United States
(12) Patent Application Publication
(10) Pub. No.: US 2013/0197992 A1
(43) Pub. Date: Aug. 1, 2013

(54) Method and System/Program for Managing and Generating Real-Time Rewards, Loyalty Points, and Advertising

(71) Applicant: Victor Bao, Miami, FL (US)

(72) Inventor: Victor Bao, Miami, FL (US)

(21) Appl. No.: 13/726,217

(22) Filed: Dec. 23, 2012

Related U.S. Application Data
(60) Provisional application No. 61/579,981, filed on Dec. 23, 2011.

(51) Int. Cl. G06Q 30/02

(52) U.S. Cl. CPC G06Q 30/0244
USPC 705/14.43

(57) ABSTRACT

The present invention is a method and system for generating real-time rewards, loyalty points, and advertising using a mobile application and quick response codes. The mobile application consists of a quick response code reader (QR Reader) which has the following components: a geo location capability; and three user options/functions directly on the QR reader. The three user options/functions are: (1) My Profile, which allows users to update their profile and store their member numbers; (2) Points, which allows users to view the points accumulated from visits to stores and frequency of visits to stores in real-time; and (3) Share, which allows users to share a QR Code with other users and vendors.

This is a substitute specification in application Ser. No. 13/726,217 submitted under 37 C.F.R. 1.125 and is accompanied by a copy with markings. This substitute specification contains no new matter.

### CROSS-REFERENCE TO RELATED APPLICATIONS

This application claims the benefit of U.S. Provisional Application No. 61/579,981 filed Dec. 23, 2011. The entire disclosure of this prior application is hereby incorporated by reference.

### STATEMENT REGARDING FEDERALLY SPONSORED RESEARCH OR DEVELOPMENT

This invention has been created without the sponsorship or funding of any federally sponsored research or development program.

### FIELD OF THE INVENTION

The present invention relates to a computerized method and system for generating, real-time rewards, loyalty points, and advertising utilizing mobile application platform and quick response codes.

### BACKGROUND OF INVENTION

Currently, consumers are able to receive online reward coupons, loyalty points, and other advertising from vendors via email which may be accessed via a computer, digital device, or mobile device. This does not allow vendors to track consumer use of coupons and points or assess the effectiveness of their advertising. Additionally, consumers have to download and print these coupons to apply discounts or present a rewards card with a barcode at the vendor's location to tabulate points and receive discounts at a later date. Alternatively, consumers have to enter account information online to register points in order to receive discount coupons at a later date.

The present invention aims to provide real-time reward coupons, loyalty points, and other discounts to consumers, while providing vendors with the ability to obtain statistical data regarding consumer spending, advertising, and product/service inventory. The process is done entirely within a mobile environment and is able to deliver real-time offers to consumers anywhere at anytime without the need for access to email. It also allows vendors access to real time information about consumption patterns whether it be consumer interest, intention to buy, geographic location, scan rates, points available, etc.

The problem for many independent small businesses is their inability to offer a loyalty program based on a rewards system that is more appealing to customers participating in their program. The platform also allows Codiscan to deliver a rewards program solution on a low monthly fee making it affordable for businesses. The Codiscan solution not only delivers a client-facing solution, it also provides operational solutions such as algorithms that calculate trends, sales forecasts, inventory re-order points, and elasticity of demand for optimal price points, etc. The Codiscan geo location also allows for key “experiential” and “observation” analysis so businesses can better understand consumer shopping patterns. For manufacturers, the Codiscan system will help improve the instruction manuals by identifying most common breakdowns in the installation process. Information about points and member profiles such as membership number are stored on the device. The Codiscan system also has a simple debit system for vendors to deduct points once they are consumed by App users. The Codiscan Mobile Application system also offers a second tier individual rewards system for individual vendors who desire a private membership program number.

### SUMMARY OF THE INVENTION

The present invention is a method and system for generating real-time rewards, loyalty points, and advertising using a mobile application and quick response codes. The mobile application consists of a quick response code reader (QR Reader) which has the following components: a geo location capability; and three user options/functions directly on the QR reader. The three user options/functions are: (1) My Profile, which allows users to update their profile and store their member numbers; (2) Points, which allows users to view the points accumulated from visits to stores and frequency of visits to stores in real-time; and (3) Share, which allows users to share a QR Code with other users and vendors.

### BRIEF DESCRIPTION OF DRAWINGS

In describing the invention, reference will, at times, be made to the accompanying drawings in which:

FIG. 1 is a screen shot of the webpage which allows a user to create or access program/system of the invention.

FIG. 2 illustrates the logic flow for accessing the computer system/program of the invention.

FIG. 3 illustrates the logic flow for the options available under the manage campaigns feature within the system/program of the invention.

FIG. 4 illustrates the logic flow for searching campaigns within the system/program of the invention.

FIG. 5 illustrates the system logic for the options available under the manage QR codes feature within the computer system/program of the invention.

FIGS. 6a and 6b illustrates the logic flow for generating QR codes within the system/program of the invention.

FIG. 7 illustrates the logic flow for generating QR codes with or without a logo and the option to add a new QR code to a template within the system/program of the invention.

FIG. 8 illustrates the system logic for the options available for searching QR codes within the system/program of the invention.

FIG. 9 illustrates the system logic for the options available under the manage Templates feature within the computer system/program of the invention.

FIG. 10 illustrates the system logic for the options available under the View Reports feature within the computer system/program of the invention.

FIG. 11 illustrates the system logic for the options available under the settings feature within the computer system/program of the invention.

FIG. 12 illustrates the system logic for the options available under the profile feature within the computer system/program of the invention.

FIG. 13 is a screen shot of the main page of the mobile software application as viewed on a mobile, digital or portable device.

FIG. 14 is a logic flow diagram illustrating how a user accesses and navigates the mobile software application of the program/system of this invention.

FIG. 15 is a logic flow diagram illustrating how a user accesses and navigates the More Options tab of the mobile software application of the program/system of this invention.

### DETAILED DESCRIPTION OF THE INVENTION

Before the subject invention is described further, it is to be understood that the invention is not limited to the particular embodiments of the invention described below, as variations of the particular embodiments may be made and still fall within the scope of the invention. It is also to be understood that the terminology employed is for the purpose of describing particular embodiments, and is not intended to be limiting.

The details of one or more embodiments of the invention are set forth in the accompanying drawings and the description below. Other features, objects, and advantages of the invention will be apparent from the description and drawings, and from the claims. In the following description, numerous specific details are set forth to provide a thorough understanding of the embodiments. One skilled in the art to which this invention belongs will recognize, however, that the techniques described can be practiced without one or more of the specific details, or with other methods, components, materials, etc. In other instances, well known structures, materials or operations are not shown or described in detail to avoid obscuring certain aspects.

In this specification, the singular forms “a,” “an” and “the” include plural references unless the context clearly dictates otherwise. Unless defined otherwise, all technical and scientific terms used herein have the same meaning as commonly understood to one of ordinary skill in the art to which this invention belongs.

### Definitions

The following terms used within the specification are defined in a way that best describes the invention and is understood by one of ordinary skill in the art to which this invention belongs as not being limiting:

“Participant-user” is defined an individual or business entity providing services or selling goods who utilizes the computer program/system of the invention to generate, view, or publish marketing/advertising campaigns.

“Vendor” is defined an individual or business entity providing services or selling goods who utilizes the computer program/system of the invention to generate, view, or publish marketing/advertising campaigns.

“Consumer” is defined as an individual who utilizes the computer/program system to view, obtain, or retrieve rewards, discounts, and loyalty points per the marketing/advertising campaign(s) published by a participant-user or Vendor.

“End-user” is defined as an individual who utilizes the computer/program system to view, obtain, or retrieve rewards, discounts, and loyalty points per the marketing/advertising campaign(s) published by a participant-user or Vendor.

“Users” is used to refer to all users collectively, including participant-users, vendors, end-users, and consumers.

“Campaign” is defined as a marketing or advertising campaign for purposes of driving consumer traffic to the participant-user locations. Campaigns include publishing discounts linked to rewards and/or loyalty points earned when a consumer visits the participant-user location and/or makes a purchase using the discount or published offer.

“Leads Captured” is a feature of the invention that allows a participant-user to obtain, gather, and utilize statistics about his marketing and advertising campaigns, consumer traffic, and its rewards and loyalty programs.

“Grab Points” is a feature of the invention allows a participant-user to set geographic parameters/geo-fencing coordinates for its store location whereby consumers who are physically within the particular latitude and longitude coordinates can earn loyalty points without making a purchase. The end-user uses this feature to find locations to earn loyalty points. The participant-user uses this feature to drive traffic in and promote its location. This information may also be used for generating reports or statistics and operates in real-time.

“Grab Offers” is feature of this invention which allows the participant-user to create offers for consumers in an effort to advance its marketing and advertising goals in real-time. The end-user uses this feature to view published offers and determine which offers to redeem or use towards a purchase. This information may also be used for generating reports or statistics and operates in real-time.

### Description

The present invention is a method and system for generating real-time rewards, loyalty points, and advertising using a mobile application and quick response codes. The mobile application consists of a quick response code reader (QR Reader) which has the following components: a geo location capability; and three user options/functions directly on the QR reader. The three user options/functions are: (1) My Profile, which allows users to update their profile and store their member numbers; (2) Points, which allows users to view the points accumulated from visits to stores and frequency of visits to stores in real-time; and (3) Share, which allows users to share a QR Code with other users and vendors. The method and process of the invention comprises as follows:
1. Create a personal webpage console on the Codiscan platform to
   a. create a specialty QR Code;
   b. view all data about their specific consumers including click rate, location scans, advertising scans, time of scan, trends, point count, grab points (enter a location), grab extra points (leave a location), intention to buy, inventory reorder point suggestions, etc.;
2. Businesses/Vendors log onto the website to generate their own customized code, in color, with an uploaded logo and an uploaded background so that they can have the code easily input into ready-to-print artwork. The codes are generated in 72 DPI, 150 DPI, 300 DPI, 600 DPI and 1,200 DPI meaning that they can print in various formats from business cards to t-shirts to billboards;
3. Businesses/Vendors decide the action/response to be taken by customer, which may include:
   Link to web
   Send a text message
   Send an email
   Send a calendar
   Send your contact information
   Generate a phone call
   Send a Tweet
   Join any social media site
   Send video
   Send schematics
   Send instructions
   Grab points
   Immediate rewards
   Web to lead (lead generation);
4. Businesses/Vendors modify offers in a real-time environment with only seconds delay to implement/display the corrected or modified action using a private console whereby they will manage their points and offers;
5. Businesses/Vendors can monitor consumer actions (what is referred to as the “intention to buy”) through its scan activity. Businesses/Vendors may register and monitor the following:
   Number of unique scans
   Time of scans
   Customer information (if customer input into the system)
   Time of scan
   QR code scanned
   Geo location capability;
6. Businesses/Vendors have ad on features they can purchase such as:
   Follow up email to join them on social media sites
   Thank you emails
   Follow up offer
   Email campaigns
   These features may be communicated to the consumer via messaging through the consumer's Codiscan mobile application (a light on their mobile app is used to signify new messages). This is a non-intrusive system;
7. Businesses/Vendors participate in a joint rewards program offering customers a series of offers against the points a customer has accumulated. Offers are determined by the businesses/Vendors themselves;
8. Businesses/Vendors communicate/send ads/make offers directly to customers from our platform in one of two ways:
   a. Via an email through the Customer Care Console (relationship platform); or
   b. Via a message light on the Mobile App allowing customers to avoid emails and opt into to “updates” on specific business offers; and
9. Businesses/Vendors with websites, blogs or placing digital ads can also add the Codiscan widget to provide incentives for visits or reading ads on line in lieu of a physical visit.
   Consumers will accumulate points based on a combination of frequency of visits to Codiscan member stores combined with the amount of time spent in stores. These points will serve as a virtual currency.

Additionally, due to the Geo capabilities of the Mobile App, consumers will be able to:
1. Grab Points: declare they have arrived at a location
2. Grab Extra Points: declare they are leaving a location
   This allows the Businesses/Vendors to tally the points accumulated per visit per day based on frequency of visits and amount of time spent in stores. For example, a minimum visit will equal 1 point; or a maximum point is 15 per location; or a maximum point per day is 15 per location; or for website visits, blogs read, digital ads read the maximum points is 3.

The debit of points will be done by each location at the moment of payment on a Debit QR Code Sheet in increments of 15 through 100, 200, 300 and 500 points. At the time of purchase a consumer is asked to please scan one of the QR Codes to receive the appropriate deduction in points. The Codiscan system will then automatically update their points on the Codiscan Mobile App.

The geo location functionality will provide the following:
1. A way for businesses to see loyal customers;
2. A way to drive traffic through a rewards program based on visits and time on locations;
3. A way for customers to be rewarded for visiting and spending time at business locations; and 4. A way of providing experimental data to businesses (intentions to buy, shopping patterns, market trends).

The following is an example of how the invention is designed to work within the framework of a business and is not meant to be limiting:
1. A business signs up to Codiscan for $50 per month
2. They are granted access to the console
3. They generate a QR Code
4. They create a response for that code
5. A customer downloads the Codiscan Mobile App
6. A customer walks into a store
7. A customer grabs points based on visits and time in store
8. A customer touches the “Points” area of the App to reveal current points available
9. A customer views all offers for specific venues (restaurants, stores, etc)
10. A business makes an offer against points
   Additionally, the CodiScan Business Model is supported by a web-based software program and a Mobile based Software program to facilitate organizations, Marketers to promote their company sales and at the same time offering a value discounts to their customer. The CodiScan web-based software program may be adaptable to other portable devices and is not limited to mobile or handheld devices.

For example, the software platform may be used for generating and promoting QR Codes for use with the following:
1. Website URL
2. Pure Text
3. SMS Text
4. Email
5. Phone Number
6. Contact Card—vCards
7. Event Details—via Calendar
8. Promotion to Social Media: Twitter, Facebook, FourSquare,
9. iTunes Store Link
10. YouTube Video
11. Paypal Buy Now Buttons for the Store
   The Technologies used for this software development, include but are not limited to the following:

### Web Platform:

Programming Languages: PHP 5.1
Database Support: MySQL 5.1
Web Server Support: APACHE 2.2
Library Support: CURL, ImageMagick, GD Lib, JQuery,
QR Encode/Decode Library Support: Zxing Library—Under Open Source GPL License
Geo Location API from http://ipinfodb.com/ip_location_api.php
QR Libraries from http://phpqrcode.sourceforge.net/
   Mobile Platform (iPhone):
SDK—iOS 4 & Above, Architecture v6 & above.
Development Platform XCode
Programming Languages: Objective C, COCOA
Database Support: SQLLite
Web Server Integration: PHP-APACHE
Library Support: Facebook API, Twitter API
QR Encode/Decode Library Support: Zxing Library—Under Open Source GPL License

### Mobile Platform (Android):

Android SDK for Platform 2.2
Programming Languages: Core Java
Database Support: SQLLite
Web Server Integration: PHP-APACHE
Development Platform: Eclipse
QR Encode/Decode Library Support: Zxing Library—Under Open Source GPL License

### Mobile Platform (Blackberry):

BlackBerry JRE 5.0 & above
JDK 6.0
Programming Languages: Core Java
Database Support: SQLLite, PersistsStorage
Web Server Integration: PHP-APACHE
Development Platform: Blackberry Eclipse IDEs
QR Encode/Decode Library Support: Zxing Library—Under Open Source GPL License, QRCoder Libraries

### Detailed Description of the Drawings

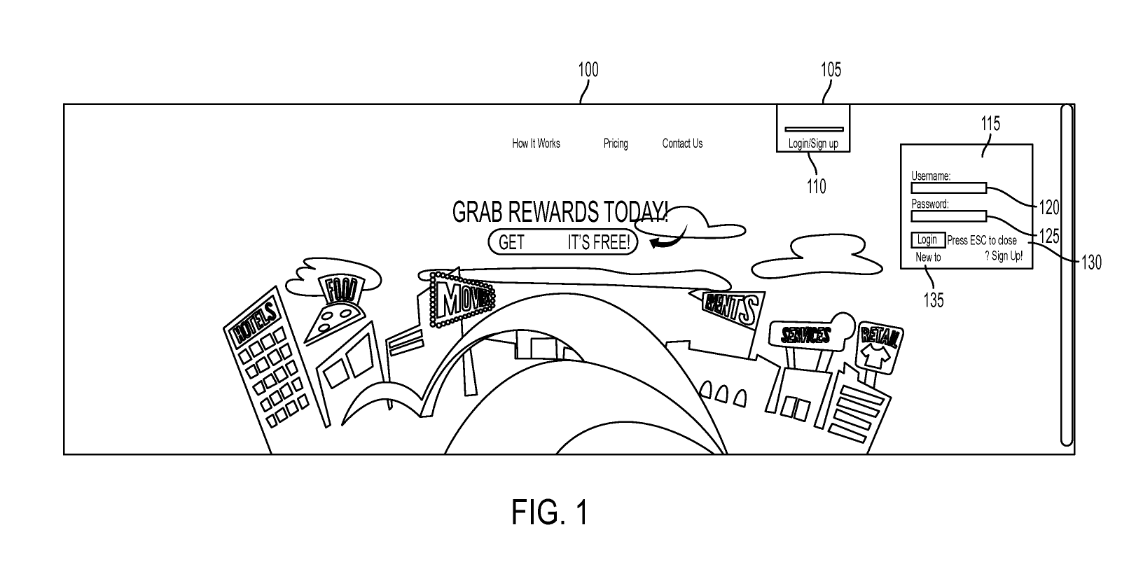

In describing the invention, FIG. 1 is a computer screen shot of the webpage 100 which allows a participant-user to create or access an account for managing, viewing, and generating rewards, discount, and loyalty points program within the computer program/system of the invention. To access the computer program/system, the participant-user inputs via mouse or keyboard to activate the login/sign up feature of the system. A user input is not limited to mouse or keyboard, but may include voice command, a tab, swipe or any other method for inputting information that is known to one of ordinary skill in the art to which this invention belongs. The input is to a small login box 105 containing a login/sign up button 110 which prompts the display of a larger login information box 115. The login information box 115 comprises an enter username box 120, an enter password box 125, a login button 130, and a new participant sign up button 135.

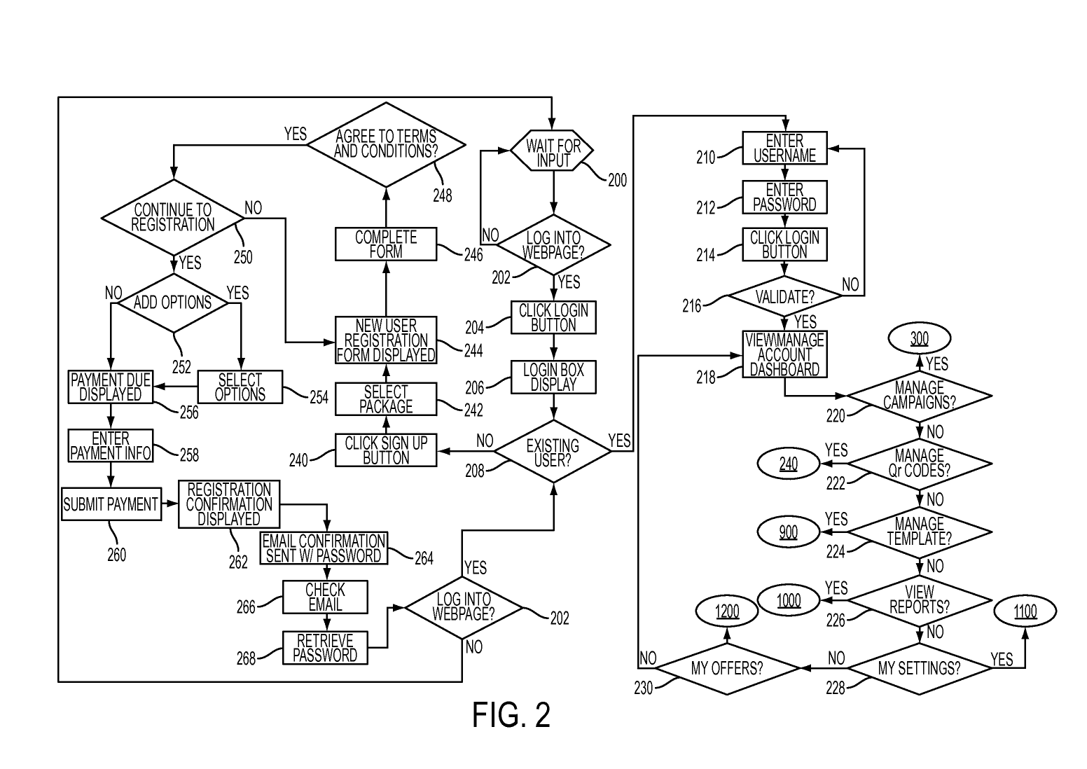

FIG. 2 shows the internal logic flow for accessing the system/program of the invention. As shown in FIG. 2, the system waits for input from the participant-user at block 200 and upon receiving input transfers control to block 202 where based upon the participant-user's input the system determines whether to log into the webpage 100. If the system determines that the participant-user is not logging into the webpage 100, then control is transferred back to block 200 to wait for input from the participant-user. If the system determines that the participant-user is logging into the webpage 100, then control is transferred to block 204 where the participant-user enters input to the login/sign up button 110 and transfers control to block 206 where the larger login information box 115 is displayed. Control is then transferred to block 208 where the system determines whether the participant-user has an existing account or needs to sign up as a new participant-user. If the participant-user has an existing account, control is transferred to block 210 where the existing participant-user is prompted to enter his previously created username into the username box 120. Control is then transferred to block 212 where the existing participant-user is prompted to enter his previously assigned password into the password box 125. Once the username and password are entered, control is transferred to block 214 where the participant-user inputs to the login button 135 located in the larger login information box 115 and control is transferred to block 216 where the system validates the username and password entered. If the system cannot validate the username and password entered, control is transferred back to block 208 where an error message is displayed and the participant-user is prompted to either repeat the login process or sign up as a new participant-user and control is transferred to block 240. If the system is able to validate the username and information entered, then control is transferred to block 218 where a participant-user dashboard is displayed for viewing and managing his account within the system/program of the invention.

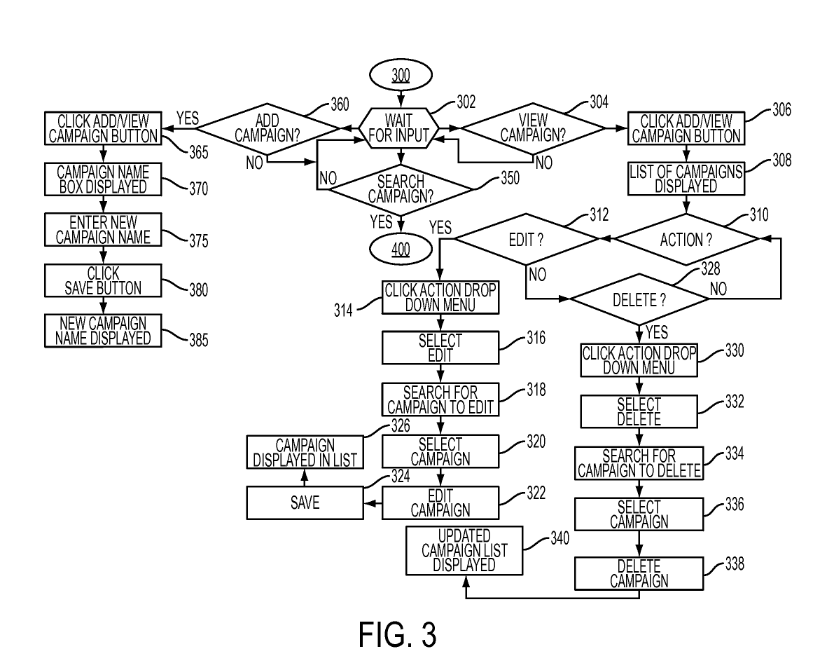

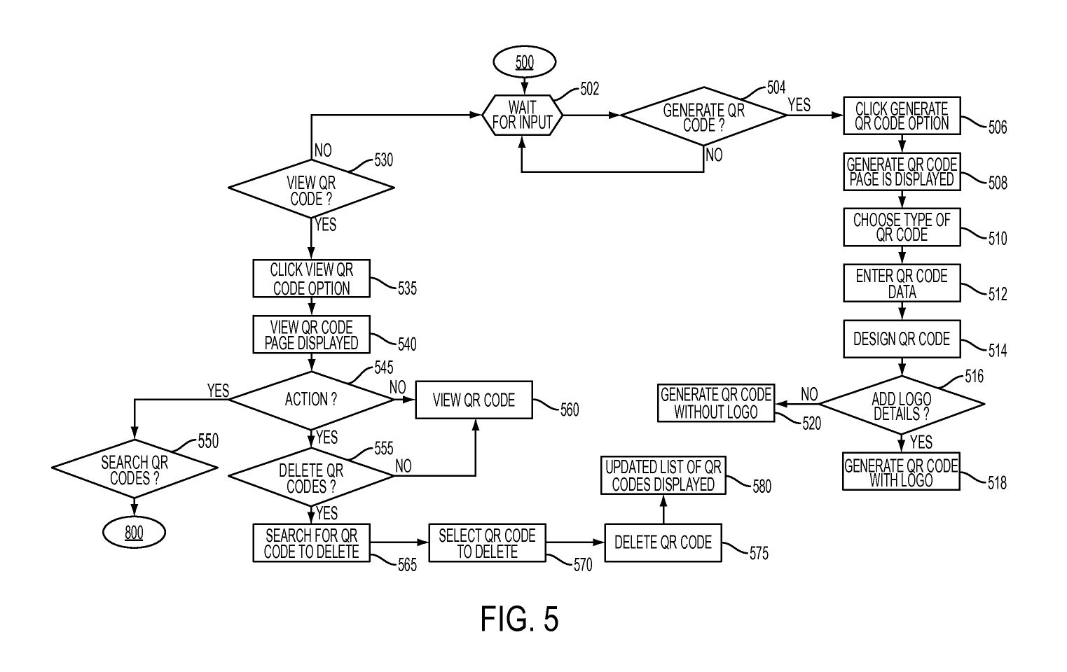

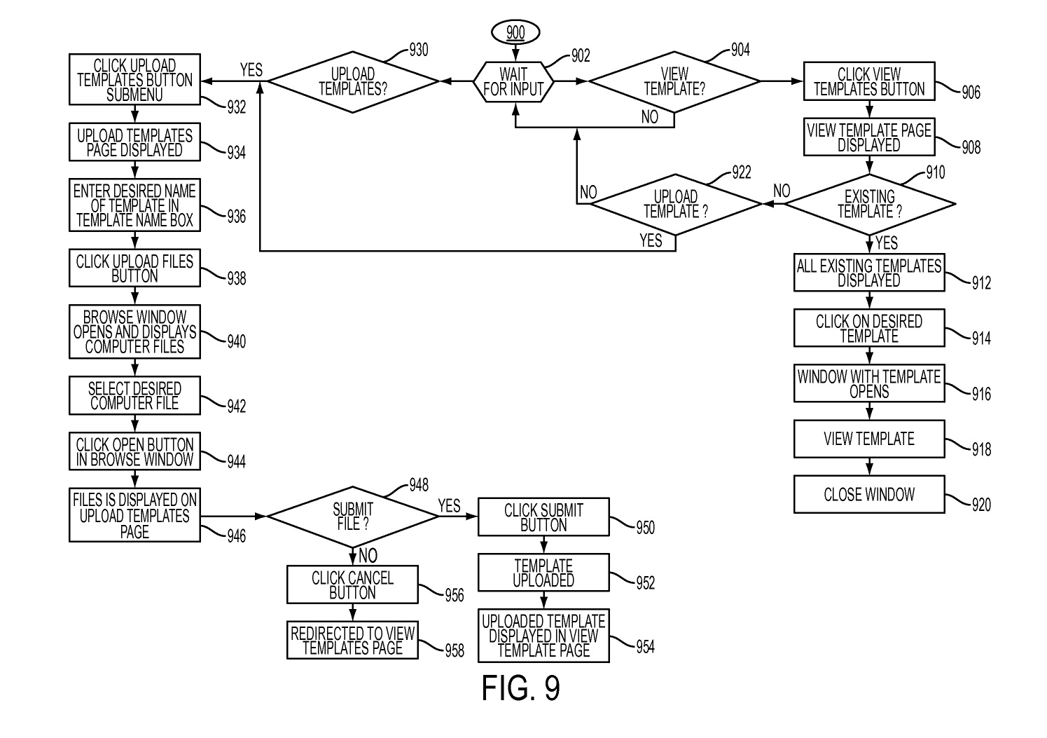

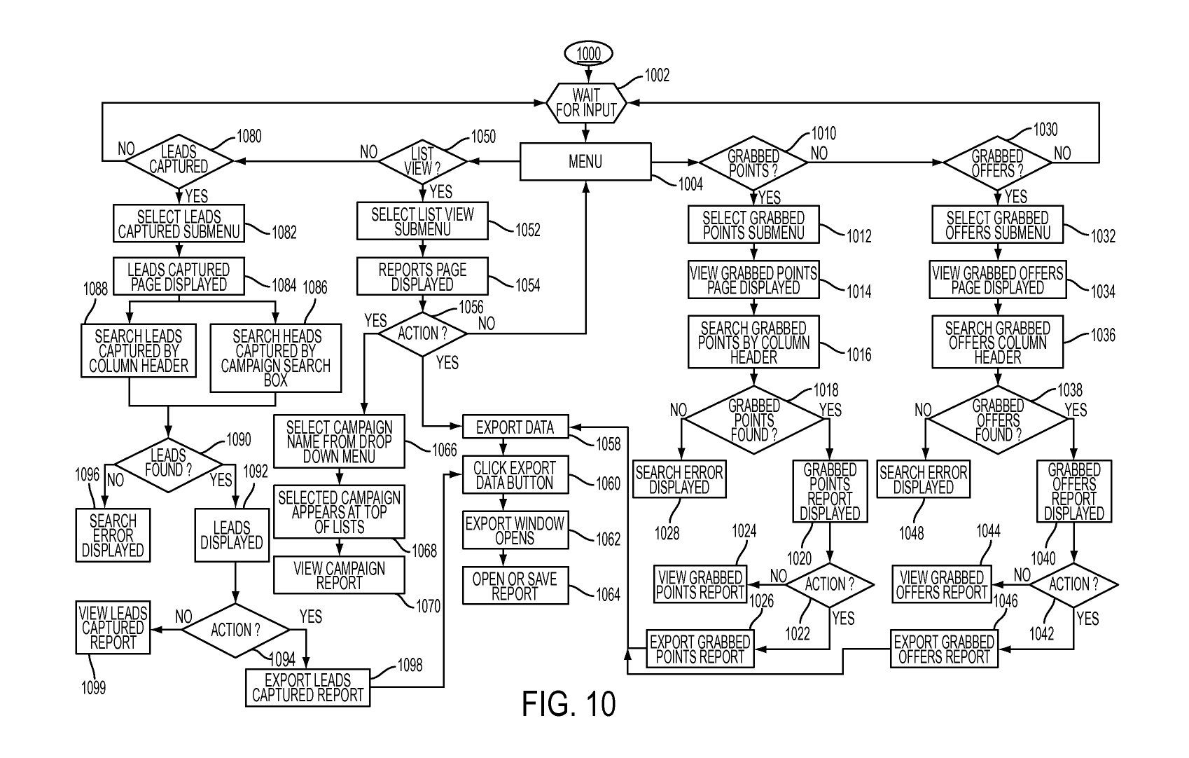

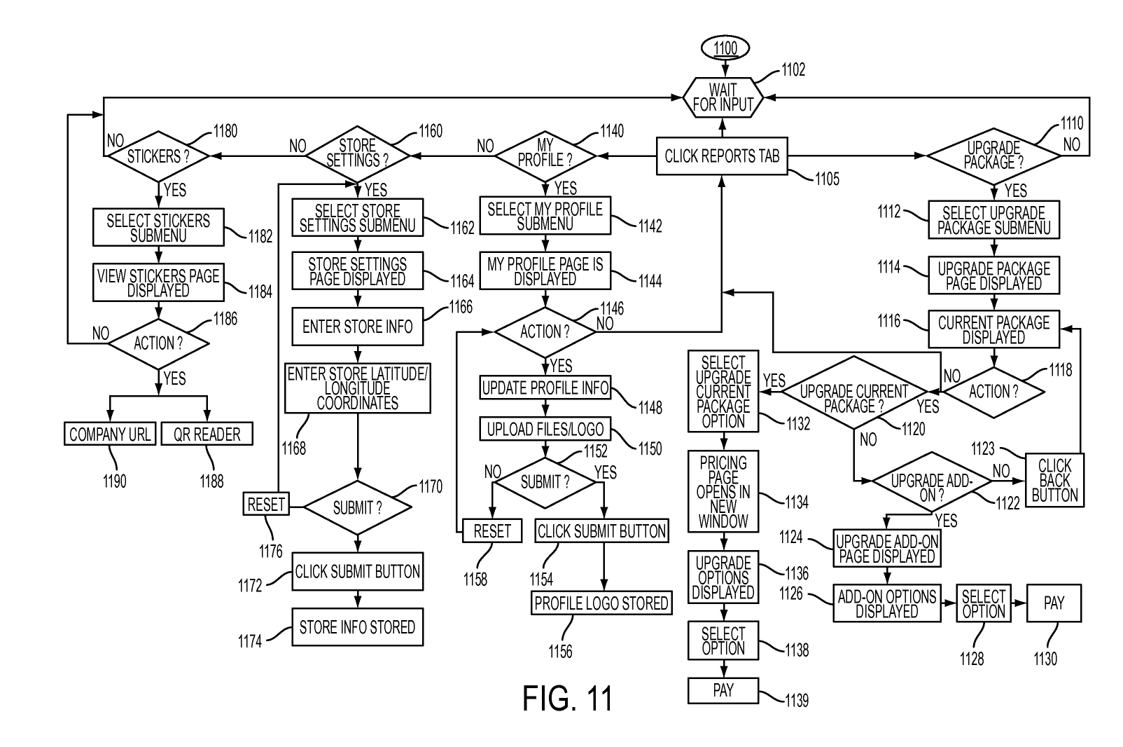

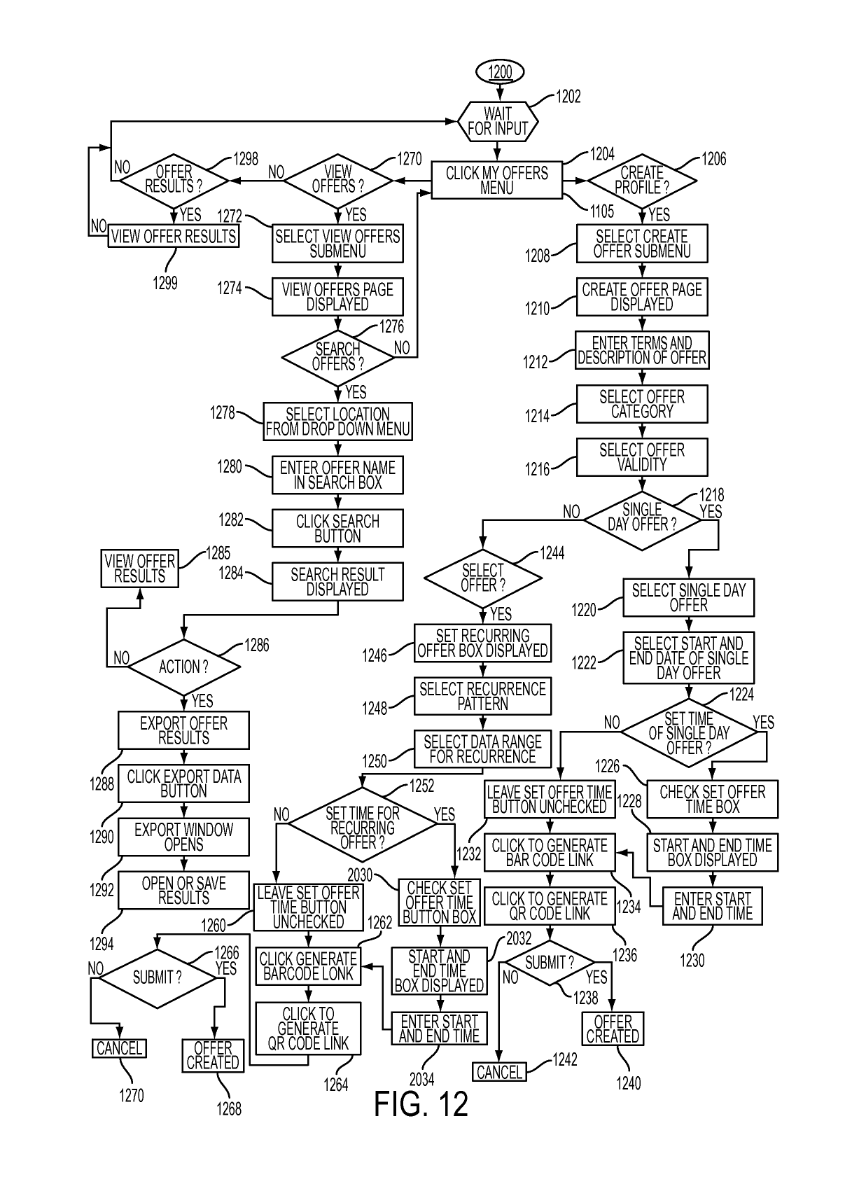

The participant user dashboard comprises menus and submenus for viewing and managing his account. The menus include “Manage Campaigns”, “Manage QR Codes”, “Manage Template”, “View Reports”, “My Settings”, and “My Offers”. Participant-user input transfers control from block 218 to block 220 where the system determines whether to access/display the “Manage Campaign” menu. If yes, then control is transferred to block 300 where the system goes through the process for managing campaigns as shown in FIG. 3. If the system determines that the participant-user does not wish to access the “Manage Campaigns” menu, then control is transferred to block 222 where the system determines whether to access/display the “Manage QR Codes” menu. If yes, then control is transferred to block 500 where the system goes through the process for managing QR codes as shown in FIG. 5. If the system determines that the participant-user does not wish to access the “Manage QR Codes” menu, then control is transferred to block 224 where the system determines whether to access/display the “Manage Templates” menu. If yes, then control is transferred to block 900 where the system goes through the process for managing templates as shown in FIG. 9. If the system determines that the participant-user does not wish to access the “Manage Templates” menu, then control is transferred to block 228 where the system determines whether to access/display the “View Reports” menu. If yes, then control is transferred to block 1000 where the system goes through the process for viewing reports as shown in FIG. 10. If the system determines that the participant-user does not wish to access the “View Reports” menu, then control is transferred to block 228 where the system determines whether to access/display the “My Settings” menu. If yes, then control is transferred to block 1100 where the system goes through the processes for the submenus of the “My Settings” menu as shown in FIG. 11. If the system determines that the participant-user does not wish to access the “My Settings” menu, then control is transferred to block 230 where the system determines whether to access/display the “My Offers” menu. If yes, then control is transferred to block 1200 where the system goes through the processes for the submenus of the “My Offers” menu as shown in FIG. 12. If the system determines that the participant-user does not wish to access the “My Offers” menu, then control is transferred back to block 218 where the participant-user has the option to access any of the menus in the dashboard or logout of the system. Although the transition from one dashboard menu to another is described in a sequence, it is not meant to be limiting. The participant-user is able to select any of the menus or submenus in the dashboard without adhering to the described sequence. For example, the participant-user may choose to access the View Reports menu first and then transition to the Manage Templates Menu, or he may choose to access only the Manage Campaigns and then log out of the system.

At block 208, if the system determines that the participant-user does not have an existing account, he is prompted to sign up and control is transferred to block 240 where the new participant-user's input would be to the sign up button 135. Control is then transferred to block 242 where the new participant-user is prompted to select a package based on number of locations/stores, number of registered loyalty program users, number of general real time offers, number of custom QR codes, and number of templates. These package selection criteria or options are not meant to be exhaustive as additional options may be added, deleted, or further customized to meet the participant-user's needs. The packages offered within the system also include standard options including loyalty program database builder, custom loyalty program, rewards for points, customer management dashboard access and any other available options. The standard options described herein are not meant to be limiting and may be further customized, added, or deleted depending on the participant-users' need and budget. The standard packages offered within the system include Free, Professional, Business, and Enterprise. The Free package includes 1 location, up to 100 registered loyalty program users, 1 generate real time offer, 2 customized QR codes, and 1 advertising template. The Professional package includes 1 location, up to 600 registered loyalty program users, 3 generate real time offer, 6 customized QR codes, and 2 advertising templates. The Business package includes 3-10 locations, up to 750 registered loyalty program users per location, 5 generate real time offer per location, 8 customized QR codes per location, and 3 advertising templates per location. The Enterprise package includes 50-5000 locations, unlimited registered loyalty program users, unlimited generate real time offer, unlimited customized QR codes, and unlimited advertising templates. The structure and content of these packages as described herein are not meant to be limiting as the packages may be further customized to include other combination of options and ranges of options.

In FIG. 2, once the new participant-user selects a package at block 242 control is transferred to block 244, where the new user registration form is displayed. Control is then transferred to block 246 where the new participant-user is prompted to complete the new registration form and all mandatory fields are highlighted or otherwise marked. Once the new participant-user completes the registration form and submits the information for processing, the system determines whether all mandatory fields are completed. If all mandatory fields are not completed, an error message is generated prompting the user to make any necessary corrections. When the system has determined that all mandatory fields of the new registration form are completed, control is transferred to block 248 where the terms and conditions for using the system/program of the invention are displayed. The new participant-user has the opportunity to review the terms and conditions and then has the option to agree or disagree with the terms and conditions. If the new participant-user disagrees with the terms and conditions, then control is transferred back to block 242 prompting the new participant-user to start the process all over again or exit the system. If the new participant-user agrees with the terms and conditions, then control is transferred to block 250 where the system determines whether to continue with the registration process. If the new participant-user wishes to make a change to his package selection or to the registration form, then control is transferred back to block 242 or block 244. If the user decides to continue with the registration process, control is transferred to block 252 where the new participant-user is prompted to add options. At this stage the new participant-user is presented with various options for upgrading or further customizing the selected package. If the new participant-user selects any of the options presented, control is transferred to block 254 for processing of the selected options and then control is transferred to block 256 where the total amount due for the selected package and added options are displayed. If the new participant-user opts not to add options, the control is transferred to block 256 where the total amount due for the selected package is displayed. From block 256 the new participant-user enters input for processing payment and control is transferred to block 258 where he is prompted to enter payment information. Payment options may include credit card, paypal, electronic funds transfer service (EFTS) or any other mode of electronic payment processing system that is capable of being integrated into the system/program of the invention. The participant-user is prompted to submit payment information at block 260 and control is transferred to block 262 where registration confirmation is displayed. Control is then transferred to the block 264 where the system generates and sends an email confirmation with a password to new participant-user's email address entered during the registration process. The participant-user is prompted to check his email 266 and to retrieve the password 262. Once the new participant-user password is retrieved then he is able to navigate to the webpage 100 and go through the login process as an existing user, starting at block 208 as described herein. If the new participant-user opts not to log into the webpage immediately after retrieving his password, then control is transferred to block 200 and the system waits for input from the participant-user.

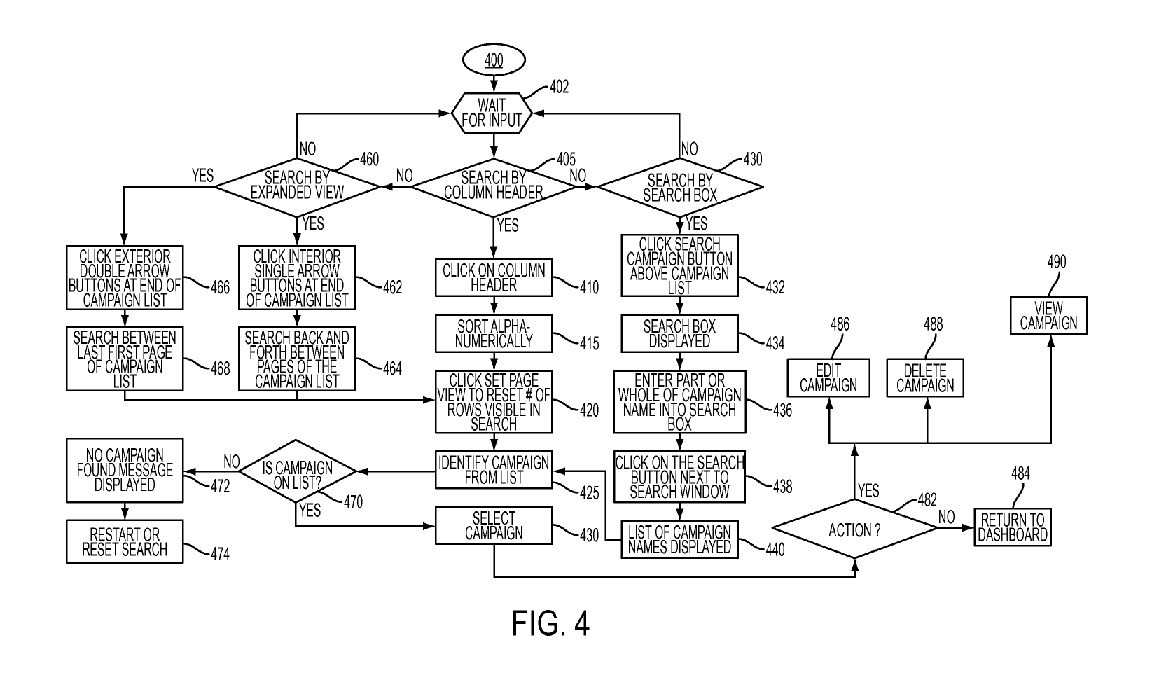

FIG. 3 illustrates the process for navigating the “Manage Campaign” menu of the participant-user dashboard. At block 300 the “Manage Campaign” page is displayed and at block 302 the system waits for input from a participant-user to select one of the options in the “Manage Campaign” submenu. The options include View Campaign, Search Campaign, or Add Campaign and selection of any of these options depends on the participant-user's input. At block 304, the system determines whether the participant-user wishes to view a campaign. If the participant-user chooses not to view a campaign, then control is transferred back to block 302 and the system waits for input. However, if the participant-user chooses to view a campaign, then control is transferred to block 306 where the participant-user enters input to the Add/View Campaign button and a list of campaigns is displayed 308. The system determines what action 310 to take based on further input from the participant-user who may choose to take action such as edit a campaign 312 or to delete a campaign 328 or to do neither, transferring control back to block 310. If the participant-user wishes to delete a campaign, then control is transferred from block 328 to block 330 where the participant-user is prompted to select the delete option from a drop down menu 332. Once the delete option is selected, then control is transferred to block 334 where the participant-user is prompted to search for a campaign to delete. The process for searching campaigns is further described in FIG. 4. Control is then transferred to block 336 where the participant-user is prompted to select a campaign and delete the selected campaign 338. Control is transferred to block 340, where the system displays an updated campaign list.

In FIG. 3, a participant-user may choose to edit a campaign, transferring control from block 312 to block 314 where the participant-user is prompted to select the edit option from a drop down menu 316. Once the edit option is selected, control is transferred to block 318 where the participant-user is prompted to search for a campaign to edit. The process for searching campaigns is further described in FIG. 4. Control is then transferred to block 320 where the participant-user is prompted to select a campaign and edit the selected campaign 322. Control is transferred to block 324, where the system prompts the participant-user to save the changes to the selected campaign, then control is transferred to block 326 where the system displays the updated campaign list.

As shown in FIG. 3, from block 302 the participant-user may enter input into the system and choose to add a campaign. At block 360 the system determines whether the participant-user wishes to add a campaign. If the participant-user chooses not to add a campaign, then control is transferred back to block 302 and the system waits for input. However, if the participant-user chooses to add a campaign, then control is transferred to block 365 where the participant-user enters input to the Add/View Campaign button and a campaign name box is displayed 370. Control is then transferred to block 375 where the system prompts the participant-user to enter a campaign name for the new campaign being added. Once the participant-user enters the desired campaign, the system prompts him to save the entry 380 and control is transferred to block 385 where an updated campaign list is displayed showing the new campaign that has been added.

As shown in FIG. 3, from block 302 the participant-user may enter input into the system and choose to search for a campaign. At block 350 the system determines whether the participant-user wishes to search for a campaign. If the participant-user chooses not to search for a campaign, then control is transferred back to block 302 and the system waits for input. However, if the participant-user chooses to search for a campaign, then control is transferred to block 400 where the system goes through the process of searching for a campaign as illustrated in FIG. 4.

In FIG. 4, the system waits for input 402 from the participant-user who must choose a method of searching for a campaign. The participant-user is able to search for a campaign by Column Header, Search Box or by Expanding View. From block 402 the participant-user may enter input into the system and choose to search for a campaign by column header. At block 405 the system determines whether the participant-user wishes to search for a campaign by column header. If the participant-user chooses not to search for a campaign by column header, then control is transferred back to block 402 and the system waits for input. However, if the participant-user chooses to search for a campaign by column header, then control is transferred to block 410 and the participant-user enters input to sort the list of campaigns alpha-numerically 415. For example, the participant-user may click on the column header “campaign” to sort the list of campaign names alphabetically in ascending or descending order. Some column headers are sortable and some column headers are not sortable. The participant-user is then able to set the number of rows of search results that are visible at one time by clicking the drop down menu for number of rows 420. The participant-user may choose to view up to 50 rows of results at one time. From the list, the participant-user identifies the campaign he is searching for 425 by highlighting it or checking a box next to it or some other method. Control is then transferred to block 470 where the system determines whether the campaign list includes a campaign that has been highlighted or otherwise identified by the participant-user. If no, then a “No Campaign Found” error message is displayed 472 and the participant-user is prompted to restart or reset search 474. If the system determines that a campaign name has been identified, then the campaign is selected 480 and the system determines what further action 482, if any, the participant-user wishes to take. If the participant-user takes no further action, then control is transferred back to the dashboard 484 as described in FIG. 2. Otherwise the participant-user may edit 486, delete 488, or view 490 the selected campaign as described in detail in FIG. 3.

In FIG. 4, from block 402 the participant-user may enter input into the system and choose to search for a campaign by search box. At block 430 the system determines whether the participant-user wishes to search for a campaign by search box. If the participant-user chooses not to search for a campaign by search box, then control is transferred back to block 402 and the system waits for input. However, if the participant-user chooses to search for a campaign by search box, then control is transferred to block 432 and the participant-user enters input to a search campaign button. Control is transferred to block 434 and a search box is displayed, the user is prompted to enter a search term into the search box 436 then click the search button next to the search box 438. The search term entered may contain a part or the whole campaign name or any word or combination of words which may identify a campaign. Control is then transferred to block 440 and the list of campaign names matching or closely matching the search box term is displayed. From the list, the participant-user identifies the campaign he is searching for 425 by highlighting it or checking a box next to it or some other method. Control is then transferred to block 470 where the system determines whether the campaign list includes a campaign that has been highlighted or otherwise identified by the participant-user. If no, then a “No Campaign Found” error message is displayed 472 and the participant-user is prompted to restart or reset search 474. If the system determines that a campaign name has been identified, then the campaign is selected 480 and the system determines what further action 482, if any, the participant-user wishes to take. If the participant-user takes no further action, then control is transferred back to the dashboard 484 as described in FIG. 2. Otherwise the participant-user may edit 486, delete 488, or view 490 the selected campaign as described in detail in FIG. 3.

As shown in FIG. 4, from block 402 the participant-user may enter input into the system and choose to search for a campaign by expanded view. At block 460 the system determines whether the participant-user wishes to search for a campaign by expanded view. If the participant-user chooses not to search for a campaign by expanded view, then control is transferred back to block 402 and the system waits for input. However, if the participant-user chooses to search for a campaign by expanded view, then control is transferred to either block 462 or 466 based on the participant-user's input. From block 462 the participant-user may choose to search by expanded view using the interior single arrow buttons displayed on the campaign list page. Control is then transferred to block 464 where the system allows the participant-user to search by back and forth between the pages of the campaign list. The participant-user is then able to set the number of rows of search results that are visible at one time by clicking the drop down menu for number of rows 420. The participant-user may choose to view up to 50 rows of results per page at one time. From the list, the participant-user identifies the campaign he is searching for 425 by highlighting it or checking a box next to it or some other method. Control is then transferred to block 470 where the system determines whether the campaign list includes a campaign that has been highlighted or otherwise identified by the participant-user. If no, then a “No Campaign Found” error message is displayed 472 and the participant-user is prompted to restart or reset search 474. If the system determines that a campaign name has been identified, then the campaign is selected 480 and the system determines what further action 482, if any, the participant-user wishes to take. If the participant-user takes no further action, then control is transferred back to the dashboard 482 as described in FIG. 2. Otherwise the participant-user may edit 486, delete 488, or view 490 the selected campaign as described in detail in FIG. 3.

In FIG. 4, from block 466 the participant-user may choose to search by expanded view using the exterior double arrow buttons displayed on the campaign list page. Control is then transferred to block 468 where the system allows the participant-user to search between the first and last page of the campaign list. The participant-user is then able to set the number of rows of search results that are visible at one time by clicking the drop down menu for number of rows 420. The participant-user may choose to view up to 50 rows of results per page at one time. From the list, the participant-user identifies the campaign he is searching for 425 by highlighting it or checking a box next to it or some other method. Control is then transferred to block 470 where the system determines whether the campaign list includes a campaign that has been highlighted or otherwise identified by the participant-user. If no, then a “No Campaign Found” error message is displayed 472 and the participant-user is prompted to restart or reset search 474. If the system determines that a campaign name has been identified, then the campaign is selected 480 and the system determines what further action 482, if any, the participant-user wishes to take. If the participant-user takes no further action, then control is transferred back to the dashboard 484 as described in FIG. 2. Otherwise the participant-user may edit 486, delete 488, or view 490 the selected campaign as described in detail in FIG. 3.

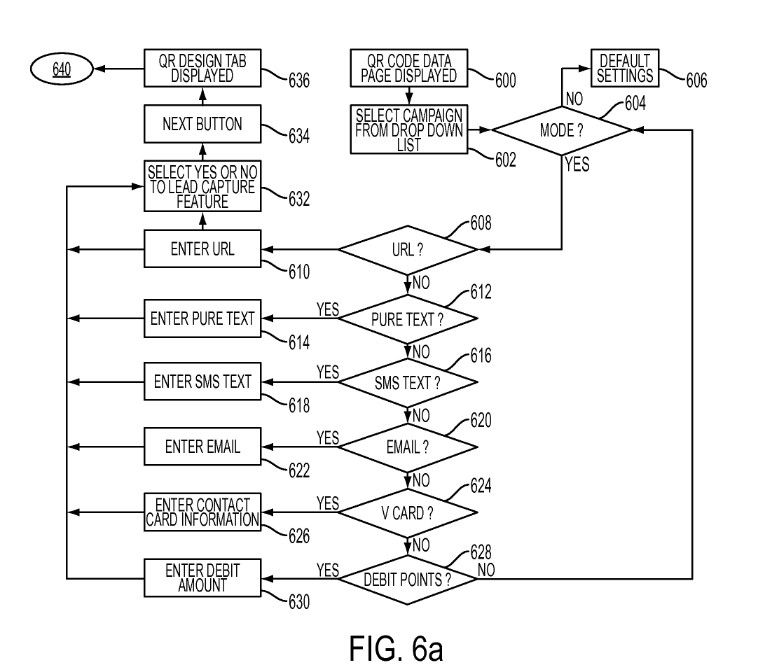

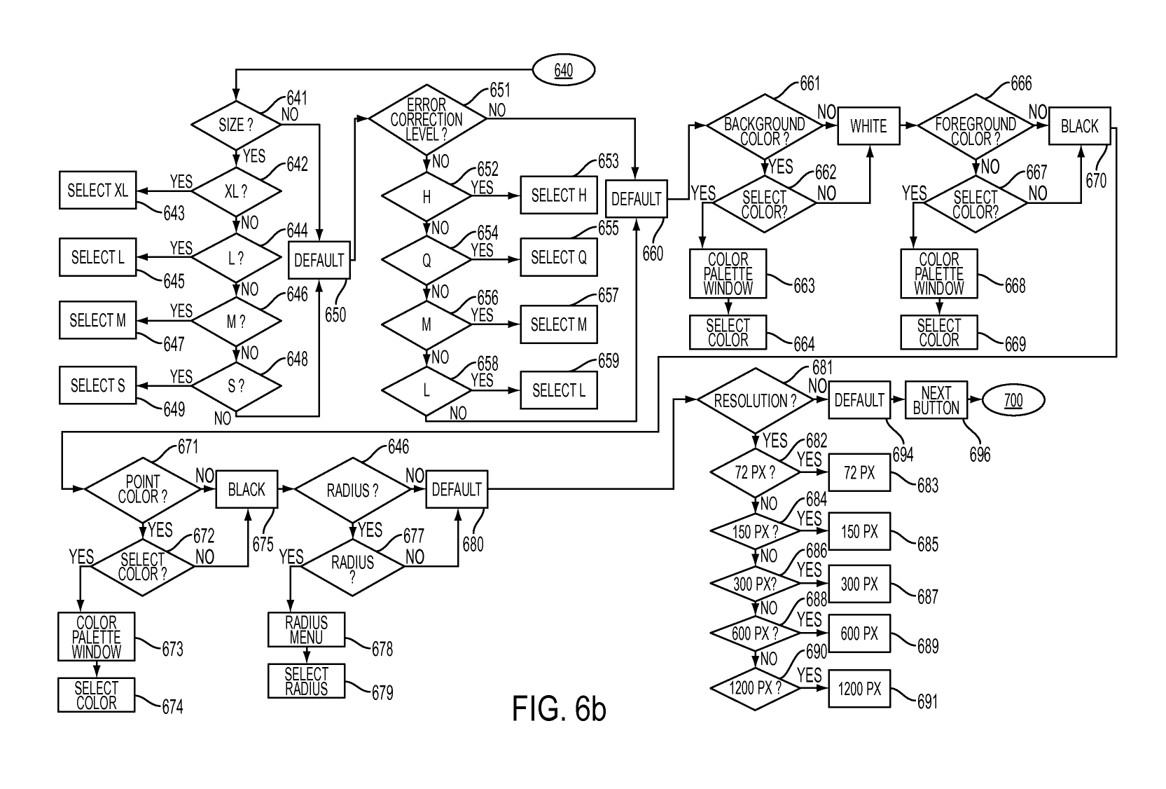

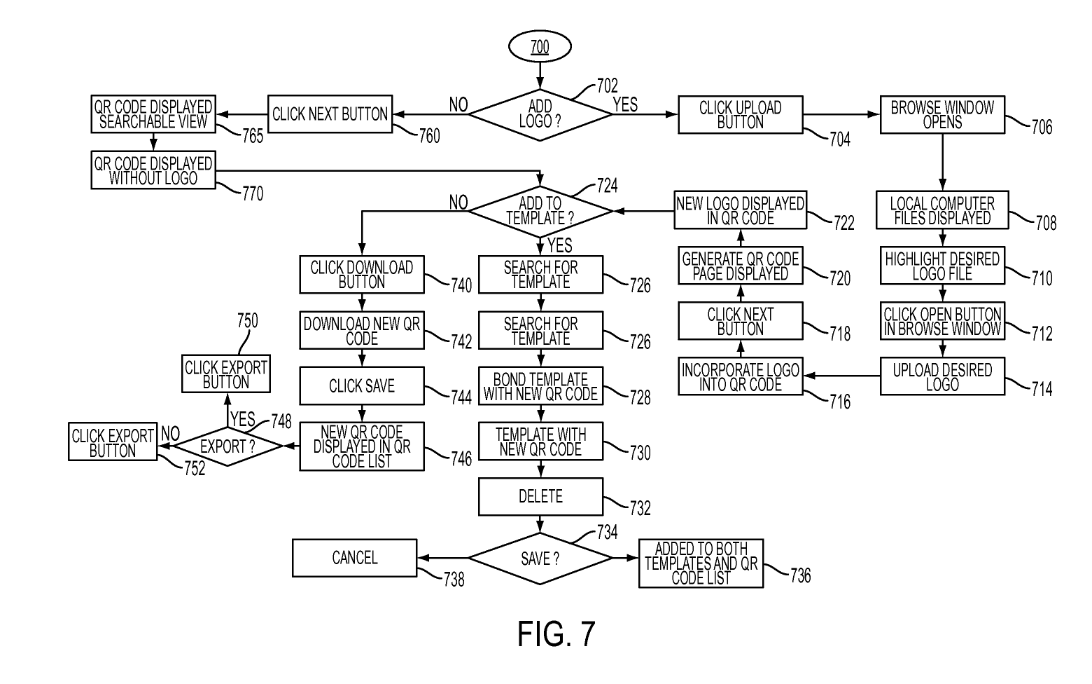

FIG. 5 illustrates the process for navigating the “Manage QR Code” menu of the participant-user dashboard. At block 500 the “Manage Campaign” page is displayed and at block 502 the system waits for input from a participant-user to select one of the options in the submenu. The options include View QR Code and Generate QR Code and selection of any of these options depends on the participant-user's input. At block 504, the system determines whether the participant-user wishes to generate a QR Code. If the participant-user chooses not to Generate a QR Code, then control is transferred back to block 502 and the system waits for input. However, if the participant-user chooses to generate a QR Code, then control is transferred to block 506 where the participant-user enters input to the Generate QR Code button and a list of QR codes is displayed 508. If this is the first time, the participant-user is using the Generate QR Code feature of the system, then the list of QR Codes is empty. The participant-user is prompted to choose the type of QR Code to generate 510, then to enter QR Code data 512, and then to design the QR Code 514. The process for generating, entering data for, and designing a QR Code is described in further detail in FIGS. 6a and 6b. Once the QR Code design is completed, the participant-user enters input and the system determines whether a logo is to be added to the QR Code 516. If no, then the system generates the QR Code without the logo 520. However, if the system determines that a logo is to be added to the QR Code, control is transferred to block 518 and the system generates the QR Code with a logo. The process for adding a logo to a QR Code is described in further detail in FIG. 7.

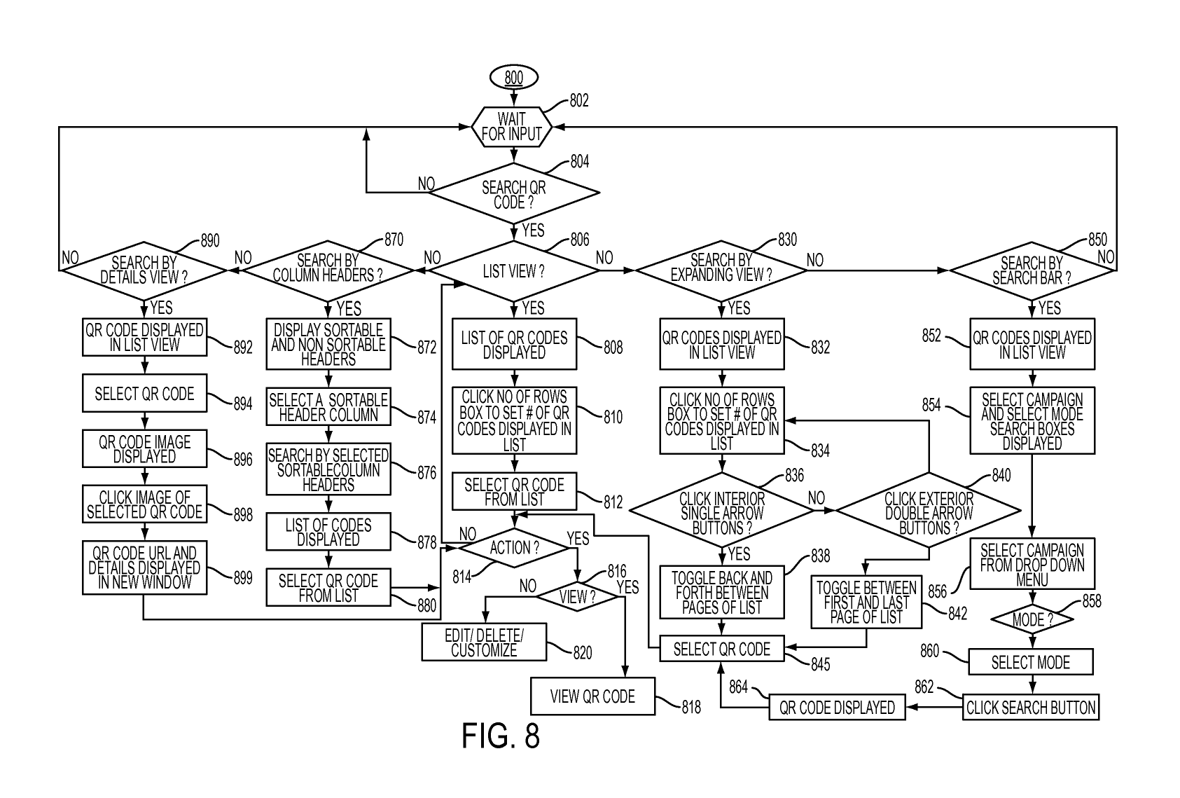

In FIG. 5, at block 530 the system determines whether the participant-user wishes to View QR Codes. If the participant-user chooses not to View QR Codes, then control is transferred back to block 502 and the system waits for input. However, if the participant-user chooses to view QR Codes, then control is transferred to block 535 where the participant-user enters input to the View QR Code option and a list of QR Codes is displayed 540. Control is transferred to block 545 where the system determines what action to take based on the participant-user's input. The participant-user may choose to take no action and simply view QR Codes 560, or take action and search QR Codes 550, or take action and delete QR Codes 555. If the participant-user opts to search QR Codes, then control is transferred to block 800 where the process for searching QR Codes is described in detail in FIG. 8. However, if the participant-user chooses to delete QR Codes, then control is transferred to block 565 to search for the QR Code the participant-user wishes to delete. A QR Code is identified for deletion by highlighting it or checking a box next to it or by some other method, then control is transferred to block 570 where the QR Code is selected. Control is transferred to block 575, where the participant-user is prompted to enter input to delete the selected QR Code and an updated QR Code list is displayed 580.

FIGS. 6a and 6b illustrate the process for entering data, designing, and ultimately generating a QR Code under the “Manage QR Codes” menu of the participant-user dashboard. The process in FIG. 6a begins at block 600 where the participant-user has already chosen the Generate QR Code submenu 506 and the Generate QR Code Page is displayed 508 as shown in FIG. 5. The Generate QR Code Page comprises a series of tabs, including a QR Code Data Tab, a QR Design Tab, a Logo Details Tab, and a Generate QR Code Tab. Each tab represents the sequence of steps that the participant-user must navigate and complete before moving on to the next step/tab. Starting at block 600 the QR Code Data Page is displayed and the participant-user must first selects from a drop down menu a campaign to associate with the new QR Code 602. The drop down menu contains a list of all campaigns previously created in the system, but if the list is empty the participant-user navigates to the “Manage Campaigns” menu and adds a campaign before navigating back to the “Generate QR Code” page. Once a campaign is selected from the drop down menu 602, the participant-user must then enter input to choose the type of QR Code he wants to generate and control is transferred to block 604 where system determines whether a QR Code Mode is being selected. The participant-user may choose from the following list of QR Code Modes: URL, pure text, SMS text, Email, vCard, or Debit Points. Alternatively, the participant-user chooses not to select a type of QR Code Mode, then control is transferred to block 606 and the system selects a default QR Code Mode setting.

From block 604 in FIG. 6a, control is transferred to block 608, where the system determines whether the participant-user has selected the URL QR Code Mode. If yes, control is transferred to block 610, but if no control is transferred to block 612, where the system determines whether the participant-user has selected the Pure Text QR Code Mode. If yes, control is transferred to block 614 where the participant-user enters a URL address into the system, but if no, control is transferred to block 616, where the system determines whether the participant-user has selected the SMS Text QR Code Mode. If yes, control is transferred to block 618 where the participant-user enters a mobile or other information for receiving SMS Text into the system, but if no, control is transferred to block 620, where the system determines whether the participant-user has selected the Email QR Code Mode. If yes, control is transferred to block 622 where the participant-user enters an Email address into the system, but if no, control is transferred to block 624, where the system determines whether the participant-user has selected the vCard QR Code Mode. If yes, control is transferred to block 626 where the participant-user enters his contact information into the system, but if no, control is transferred to block 628, where the system determines whether the participant-user has selected Debit Points QR Code Mode. If yes, control is transferred to block 630 where the participant-user enters the number of points to debit for a particular campaign into the system, but if no, control is transferred back to block 604 prompting the participant-user to select a QR Code Mode or have the system select the default setting 606.

In FIG. 6a, when any of the QR Code Modes selected, control is transferred to block 632 where the participant-user may choose to enable the Lead Capture feature of the system. The lead capture feature is described in further detail in FIG. 11. Whether the participant-user selects “yes” or “no” at block 632, control is transferred to block 634 where he enters input to the Next button on the QR Data Page. From block 634 control is transferred to block 636 and the QR Design Tab is displayed. The participant-user is now prompted to design the QR Code at block 640 which is described in FIG. 6b.

FIG. 6b shows the sequence of steps for designing a QR Code. Starting at block 640 where the QR Design Tab is already displayed, the participant-user must choose from the various design options including, but not limited to QR Code size, error correction level, background color, foreground color, point color, radius, and resolution. From block 640, control is transferred to block 641 where the system determines whether a QR Code size has been selected. If no, then control is transferred to block 650 where the system selects a default size and control is transferred to the next design option at block 651. If yes, then control is transferred to block 642 where the system determines whether the QR Code size selected is XL, and if it has been selected by the participant-user control is transferred to block 643. However, if XL has not been selected by the participant-user control is transferred to block 644 where the system determines whether the QR Code size selected is L, and if it has been selected by the participant-user control is transferred to block 645. However, if L has not been selected by the participant-user control is transferred to block 646 where the system determines whether the QR Code size selected is M, and if it has been selected by the participant-user control is transferred to block 647. However, if M has not been selected by the participant-user control is transferred to block 648 where the system determines whether the QR Code size selected is S, and if it has been selected by the participant-user control is transferred to block 649. If the system determines that no size design option has been selected, control is transferred to block 650 where the system selects a default size and control is transferred to the next design option at block 651.

In FIG. 6b at block 651, the system determines whether a QR Code error correction level has been selected. If no, then control is transferred to block 659 where the system selects a default error correction level and control is transferred to the next design option at block 661. If yes, then control is transferred to block 652 where the system determines whether the QR Code error correction level selected is H, and if it has been selected by the participant-user control is transferred to block 653. However, if H has not been selected by the participant-user control is transferred to block 654 where the system determines whether the QR Code error correction level selected is Q, and if it has been selected by the participant-user control is transferred to block 655. However, if Q has not been selected by the participant-user control is transferred to block 656 where the system determines whether the QR Code error correction level selected is M, and if it has been selected by the participant-user control is transferred to block 657. However, if M has not been selected by the participant-user control is transferred to block 658 where the system determines whether the QR Code error correction level selected is L, and if it has been selected by the participant-user control is transferred to block 659. If the system determines that no error correction level design option has been selected, control is transferred to block 659 where the system selects a default error correction level and control is transferred to the next design option at block 661.

In FIG. 6b at block 661, the system determines whether a QR Code background color has been selected. If no, then control is transferred to block 665 where the system selects the default background color white and control is transferred to the next design option at block 666. If yes, then control is transferred to block 662 where the participant-user is prompted to select a color from a color palette window at block 663. Control is transferred to block 664 where the participant-user selects a color and moves on to the next design option at block 666. At block 666, the system determines whether a QR Code foreground color has been selected. If no, then control is transferred to block 670 where the system selects the default foreground color black and control is transferred to the next design option at block 671. If yes, then control is transferred to block 667 where the participant-user is prompted to select a color from a color palette window at block 668. Control is transferred to block 669 where the participant-user selects a color and moves on to the next design option at block 671.

In FIG. 6b at block 671, the system determines whether a QR Code point color has been selected. If no, then control is transferred to block 675 where the system selects the default point color black and control is transferred to the next design option at block 676. If yes, then control is transferred to block 672 where the participant-user is prompted to select a color from a color palette window at block 673. Control is transferred to block 674 where the participant-user selects a color and moves on to the next design option at block 676. At block 676, the system determines whether a QR Code radius size has been selected. If no, then control is transferred to block 680 where the system selects the default radius size and control is transferred to the next design option at block 681. If yes, then control is transferred to block 677 where the participant-user is prompted to select radius size from a drop down menu at block 678. Control is transferred to block 679 where the participant-user selects a radius size and moves on to the next design option at block 681.

In FIG. 6b at block 681, the system determines whether a QR Code resolution value has been selected. If no, then control is transferred to block 694 where the system selects a default resolution value. If yes, then control is transferred to block 682 where the system determines whether the QR Code resolution value selected is 72 pixels, and if it has been selected by the participant-user control is transferred to block 683. However, if the 72 pixels resolution value has not been selected by the participant-user control is transferred to block 684 where the system determines whether the QR Code resolution value selected is 150 pixels, and if it has been selected by the participant-user control is transferred to block 685. However, if the 150 pixels QR Code resolution value has not been selected by the participant-user control is transferred to block 686 where the system determines whether the QR Code resolution value selected is 300 pixels, and if it has been selected by the participant-user control is transferred to block 687. However, if the 300 pixels QR Code resolution value has not been selected by the participant-user control is transferred to block 688 where the system determines whether the QR Code resolution value selected is 600 pixels, and if it has been selected by the participant-user control is transferred to block 689. However, if the 600 pixels resolution value has not been selected by the participant-user control is transferred to block 690 where the system determines whether the QR Code resolution value selected is 1200 pixels, and if it has been selected by the participant-user control is transferred to block 691. If the system determines that no resolution design option has been selected, control is transferred to block 694 where the system selects a default resolution value and control is transferred to block 696 where the participant-user enters input to the next button and control is transferred to block 700 to the Logo Details Tab of the Generate QR Code submenu.

FIG. 7 is a logic flow diagram illustrating the process for adding a logo to a QR Code that has being generated by the program/system of the invention. At block 700 the participant-user has already navigated to the Logo Details Tab of the Generate QR Code submenu as shown in FIG. 6b. The participant-user enters input into the system and the system determines whether to add a logo 702. If the participant-user chooses to add a logo to the QR Code being generated, then control is transferred to block 704 where the participant-user is prompted to click the upload button which action opens up a browse window 706 in the Logo Details Tab. From the browse window, local computer files are displayed 708 and the participant-user highlights the desired logo file 710 and then clicks the open button in the browse window 712 to upload the desired logo 714. The uploaded logo is incorporated in the QR Code that is being generate 716 an the participant-user is prompted to click the next button 718 and the Generate QR Code Page is displayed 720. On the Generate QR Code Page, the new QR Code is displayed with the logo 722 and control is transferred to block 726 where the system determines whether to add the new QR Code with logo to a template.

As shown in FIG. 7, if the system determines that the new QR Code with the logo is being added to a template, then control is transferred to block 726 to search for a template. Once a template is selected, then control is transferred to block 728 where the template is bonded with the new QR Code and logo and the template with new QR Code and logo is displayed 730. Control is transferred to block 734 where the system determines whether to save the template with new QR Code and logo. If the participant-user desires to save the template with new QR Code and logo generated, then control is transferred to block 736 and the template with new QR Code and logo is added to the list of QR Codes and the list of Templates stored within the system. If the participant-user does not desire to save the template with new QR Code and logo generated, the control is transferred to block 738 and the template with new QR Code and logo generated is canceled from the system.

In FIG. 7 at block if the participant chooses not to add the template with new QR Code and logo generated to a template, then control is transferred to block 740 where he is prompted to click the download button and the new QR Code with logo is downloaded 742. Control is transferred to block 744 where the system determines whether to save the new QR Code and logo. If the participant-user desires to save the new QR Code and logo generated, then control is transferred to block 746 and the new QR Code and logo is now displayed in the list of QR Codes stored within the system. The participant-user now has the option to export the new QR Code and logo generated and save/store it outside of the system. At block 748 the system determines whether to export the new QR Code and logo generated. If the participant-user wishes to export the new QR Code and logo generated, then he clicks the export button 750 to do so. Otherwise, if the participant-user chooses not to export the new QR Code and logo generated, then control is transferred to block 752 where he can view the new QR Code and logo generated. At block 744 if the participant-user does not desire to save the new QR Code and logo generated, control is transferred to block 747 and the new QR Code and logo generated is canceled from the system.

As shown in FIG. 7, at block 702 the participant-user may not choose to add a logo to the new QR Code being generated. When the system determines this based on the participant-user's input, then control is transferred to 760 and the participant-user is prompted to click the next button to the Generate QR Code Tab 765 where the new QR Code without a logo is displayed 770. Control is transferred to block 724 where the system determines whether to add the new QR Code without logo to a template. The system, based on input from the participant-user, follows the same process as previously described for adding or not adding the new QR Code and logo to a template but now recognizes that the QR Code generated does not include a logo.

FIG. 8 is a flow diagram illustrating the options for searching QR Codes within the program/system of the invention. In FIG. 4, the system waits for input 802 from the participant-user who must choose a method of searching for a QR Code. The participant-user is able to search for a campaign by Details View, Column Header, List View, Search Box or by Expanding View. From block 802 the participant-user may enter input into the system and choose to search for a QR Code. At block 804 the system determines whether to search for a QR Code. If the participant-user chooses not to search for a QR Code then control is transferred back to block 802 where the system waits for input. However, if the participant-user chooses to search for a QR Code, then Control is transferred to block 806 where he has the option to search by List View. If the participant-user chooses to search by List View, then control is transferred to block 808 where a list of QR Codes is displayed. The participant-user enters input at block 810 to adjust/change the number of QR Codes displayed in the list and then selects a QR Code from the list 812. Control is transferred to block 814 where the system determines what action, if any, to take with the selected QR Code. If no action is taken, then control is transferred back to block 808 where the QR Codes are displayed in a list. If the participant-user decides to take action, control is transferred to block 816 where the system determines whether the QR Code selected is being viewed by the participant-user. If the QR Code selected is being viewed, then control is transferred to block 818, but if not then control is transferred to block 820 where the participant-user has the option to edit, delete or customize the selected QR Code.

At block 806 in FIG. 8, the participant-user may choose not to search QR Code by List View and instead search by column header. If the participant-user chooses to search by column header, then control is transferred to block 870 where the system makes that determination and control is then transferred to block 872 to display the sortable and non-sortable headers. The participant-user is prompted to select a sortable column header at block 874 and then search by the selected sortable column header at block 876. A list of QR Codes is displayed at block 878 and the participant-user selects the desired QR Code from the list 880. Control is transferred to block 814 where the system determines what action, if any, to take with the selected QR Code. If no action is taken, then control is transferred back to block 804 where the system determines whether to search for a QR Code and repeat the process. If the participant-user decides to take action, control is transferred to block 816 where the system determines whether the QR Code selected is being viewed by the participant-user. If the QR Code selected is being viewed, then control is transferred to block 818, but if not then control is transferred to block 820 where the participant-user has the option to edit, delete or customize the selected QR Code.

At block 870 in FIG. 8, the participant-user may choose not to search QR Code by column header but instead to search by Details View. If the participant-user chooses to search by details view, then control is transferred to block 890 where the system makes that determination and control is then transferred to block 892 to display the QR Codes in List View. The participant-user is prompted to select a QR Code from the list at block 894 and the QR Code image is displayed at block 896. The participant-user clicks on the image of the selected QR Code 898 and the QR Code Details, including URL are displayed in a new window 899. Control is transferred to block 814 where the system determines what action, if any, to take with the selected QR Code. If no action is taken, then control is transferred back to block 804 where the system determines whether to search for a QR Code and repeat the process. If the participant-user decides to take action, control is transferred to block 816 where the system determines whether the QR Code selected is being viewed by the participant-user. If the QR Code selected is being viewed, then control is transferred to block 818, but if not then control is transferred to block 820 where the participant-user has the option to edit, delete or customize the selected QR Code.

At block 890 in FIG. 8, the participant-user may choose not to search QR Code by column header but instead to search by Expanding View. If the participant-user chooses to search by expanding view, then control is transferred to block 830 where the system makes that determination and control is then transferred to block 832 to display the QR Codes in List View. The participant-user enters input at block 834 to adjust/change the number of QR Codes displayed in the list. The participant-user is able to set the number of rows that are visible at one time by clicking a drop down menu and selecting the number of rows. The participant-user may choose to view up to 50 rows in the list at one time. Control is then transferred to block 836 where the participant-user may choose to search by expanded view using the interior single arrow buttons displayed on the QR Code Search page. If the participant-user chooses to search by expanded view using the interior single arrow buttons, control is transferred to block 838 where the system allows the participant-user to search back and forth between the pages of the QR Code list. If the participant-user chooses not to search by expanded view using the interior single arrow buttons, control is transferred to block 840 where he may search by expanded view using exterior double arrow buttons. Control is transferred to block 842 where the system allows the participant-user to search back and forth between the first and last pages of the QR Code list. From either block 838 or 842 control is transferred to block 845 to select a QR Code from the list and then Control is transferred to block 814 where the system determines what action, if any, to take with the selected QR Code. If no action is taken, then control is transferred back to block 808 where the QR Codes are displayed in a list. If the participant-user decides to take action, control is transferred to block 816 where the system determines whether the QR Code selected is being viewed by the participant-user. If the QR Code selected is being viewed, then control is transferred to block 818, but if not then control is transferred to block 820 where the participant-user has the option to edit, delete or customize the selected QR Code.

At block 830 in FIG. 8, the participant-user may choose not to search QR Code by Expandable View, but instead to search using a Search Box. If the participant-user chooses to search by using a search box, then control is transferred to block 850 where the system makes that determination and control is then transferred to block 852 to display the QR Codes in List View. Control is transferred to block 854 where the “select campaign” and “select mode” boxes are displayed. At block 856 the participant-user is prompted to select a campaign associated with a QR Code from a drop down menu inside the “select campaign” box, then control is transferred to block 858 where the system determines whether to select a mode from a drop down menu inside the “select mode” box. The QR Code mode has already been set through the QR Code process as described in FIG. 6a and is only available in the select “select mode” box drop down menu for a campaign associated with a QR Code that has been previously generated and saved in the system. At block 860 the participant-user is prompted to select a mode from the drop down menu located inside the “select mode” box and then click the search button on the View QR Codes page 862. The desired QR Code is displayed 864 at the top of the QR Code List, the participant-user selects it 864 control is transferred to block 814 where the system determines what action, if any, to take with the selected QR Code. If no action is taken, then control is transferred back to block 808 where the QR Codes are displayed in a list. If the participant-user decides to take action, control is transferred to block 816 where the system determines whether the QR Code selected is being viewed by the participant-user. If the QR Code selected is being viewed, then control is transferred to block 818, but if not then control is transferred to block 820 where the participant-user has the option to edit, delete or customize the selected QR Code.

FIG. 9 illustrates the process for navigating the “Manage Templates” menu of the participant-user dashboard. At block 900 the “Manage Campaign” page is displayed and at block 902 the system waits for input from a participant-user to select one of the options in the “Manage Templates” submenu. The options include View Templates and Upload Templates and selection of any of these options depends on the participant-user's input. At block 904 the system determines whether the participant-user wishes to view a template. If the participant-user does not wish to view a template, then control is transferred back to block 902 and the system waits for input. However, if the participant-user chooses to view a template, then control is transferred to block 906 where the participant-user enters input to the View Templates button and and the View Templates page is displayed 908. At block 910 the system determines whether there is an existing template to be viewed and if yes, control is transferred to block 912 where all existing templates are displayed. The participant-user then clicks or otherwise enters input on the desired template 914 and a new window with the desired template opens 916 and the participant-user is now able to view the template 918. Once the participant-user has finished viewing the template, then he may close the window 920 showing the template and move on to another action.

In FIG. 9, at block 910 if the system determines that there are no existing templates, the control is transferred to block 922 where a decision is made whether to upload a template. If the system determines not to upload a template, then control is transferred back to block 902. However, if the system determines to upload a template, then control is transferred to block 930, the Upload Template submenu of the Manage Tamplates Menu. At block 930 if the participant-user enters input and the system determines not to upload templates, then once again control is transferred back to block 902 where the system waits for input. If the participant-user enters input for uploading a template, control is transferred from block 930 to 932 where the participant-user clicks or otherwise enters input to the Upload Templates Button and the Upload Templates Page is displayed 934. The Upload Templates Page comprises a Template Name Box, an Upload Files Button, a Submit Button and a Cancel Button. On the Upload Templates Page the participant-user is prompted to enter the desired name for a template in the Template Name Box 936 and then click or otherwise enter input to the Upload Files Button 938. A browse window opens up and displays computer files 940 and the participant-user selects the desired computer file 942 and clicks or otherwise enters input to the Open Button in the Browse Window 944 and control is transferred to block 946 where the file is displayed on the Upload Templates page. The system then determines whether to submit the file 948 and if the decision is no, then control is transferred to block 956 where the participant-user is prompted to click the Cancel Button and is redirected to the View Templates page 958. If the decision at block 948 is to submit the file, then control is transferred to block 950 where the participant-user clicks or otherwise enters input to the Submit Button, the template file is uploaded 952, and control is transferred to block 954 where the uploaded template is displayed on the View Template page.

FIG. 10 illustrates the process for navigating the “Reports” menu of the participant-user dashboard. At block 1000 the “Reports” page is displayed and at block 1002 the system waits for input from a participant-user to select one of the options in the “Reports” submenu. The options include List View, Leads Captured, Grabbed Points, and Grabbed Offers. From block 1002 the participant-user clicks or otherwise enters input to the Reports Menu 1004 and is able to further enter input to navigate to one of the options in the Reports submenu. Based on the participant-user's input, control may be transferred from block 1004 to block 1010 where the system determines whether to access the Grabbed Points submenu of the Reports Menu. If yes, the control is transferred to block 1012 where the participant-user is prompted to select the Grabbed Points Submenu, resulting in a View Grabbed Points Page being displayed 1014. The participant-user is now able to search Grabbed Points by Column Header 1016 and the system determines whether any Grabbed Points information/report is found 1018. If no Grabbed Points information/report is found, then control is transferred to block 1028 and the system displays a search error message. If Grabbed Points information/report is found, then control is transferred to block 1020 where a Grabbed Points Report is displayed. The participant-user then enters input and control is transferred to block 1022 where the system determines what action, if any to take with regards to the Grabbed Points report. If the decision is to take no action, then control is transferred to block 1024 and the participant-user is able to view the report on the Grabbed Points page. If the participant-user chooses to take action, then control is transferred to block 1026 for the system to export the Grabbed Points Report. From block 1026 control is transferred to block 1058 to export the data, then the participant-user clicks or otherwise enters input into an Export Data Button 1060 and an Export Data Window Opens 1062 giving the participant-user the option to open or save the Grabbed Points report file. The report generated through this process may be exported in various formats including CSV, Excel, text and other mode known to one of ordinary skill in the art or any other supported by the program/system of the invention.

In FIG. 10, based on the participant-user's input at bloom 1010, if the system determines not to access the Grabbed Points submenu of the Reports Menu, control may be transferred to block 1030 where the system determines whether to access the Grabbed Offers submenu of the Reports Menu. If yes, then control is transferred to block 1032 where the participant-user is prompted to select the Grabbed Offers submenu, resulting in a View Grabbed Offers Page being displayed 1034. The participant-user is now able to search Grabbed Offers by Column Header 1036 and the system determines whether any Grabbed Offers information/report is found 1038. If no Grabbed Offers information/report is found, then control is transferred to block 1048 and the system displays a search error message. If Grabbed Offers information/report is found, then control is transferred to block 1040 where a Grabbed Offers Report is displayed. The participant-user then enters input and control is transferred to block 1042 where the system determines what action, if any, to take with regards to the Grabbed Offers report. If the decision is to take no action, then control is transferred to block 1044 and the participant-user is able to view the report on the Grabbed Offers page. If the participant-user chooses to take action, then control is transferred to block 1046 for the system to export the Grabbed Offers Report. From block 1046 control is transferred to block 1058 to export the data, then the participant-user clicks or otherwise enters input into an Export Data Button 1060 and an Export Data Window Opens 1062 giving the participant-user the option to open or save the Grabbed Offers report file. The report generated through this process may be exported in various formats including CSV, Excel, text and other mode known to one of ordinary skill in the art or any other supported by the program/system of the invention.

In FIG. 10, based on the participant-user's input at block 1030, if the system determines not to access the Grabbed Offers submenu of the Reports Menu, control is transferred back to block 1002 where the system waits for input. From block 1002 the participant-user clicks or otherwise enters input to the Reports Menu 1004 and is able to further enter input to navigate to one of the options in the Reports submenu. Based on the participant-user's input, control may be transferred from block 1004 to block 1050 where the system determines whether to access the List View submenu of the Reports Menu. If yes, the control is transferred to block 1052 where the participant-user is prompted to select the List View Submenu, resulting in a Reports Page being displayed 1054. The List View page comprises a Select Campaign Name Search Box with a drop down menu, list of campaigns sorted by column headers, and an Export Data Button. The participant-user enters input and control is transferred to block 1056 where the system determines what action, if any to take within the List View page. If the decision is to take no action, then control is transferred back to block 1004 and the participant-user is able to access one of the other submenus in the Reports Menu as described herein. If the participant-user chooses to take action, he is presented with the option of navigating through the Campaign Name Search Box or the Export Data Button. In order to view a campaign report, control is transferred to block 1066 and the participant-user navigates the Campaign Name Search Box by clicking or otherwise entering input to select a campaign from the drop down menu located in the Campaign Name Search Box. The selected campaign appears at the top of the List View and control is transferred to block 1070 allowing the participant-user to simply view a report on the selected campaign. In order to export a campaign report, control is transferred to block 1058 and the participant-user clicks or otherwise enters input to the Export Button 1060 and an Export Data Window Opens 1062 giving the participant-user the option to open or save the campaign report file. The report generated through this process may be exported in various formats including CSV, Excel, text and other mode known to one of ordinary skill in the art or any other supported by the program/system of the invention.

In FIG. 10, based on the participant-user's input at block 1050, if the system determines not to access the List View submenu of the Reports Menu, control may be transferred to block 1080 where the system determines whether to access the Leads Captured submenu of the Reports Menu. If yes, the control is transferred to block 1082 where the participant-user is prompted to select the Captured Leads Submenu, resulting in a Leads Captured page being displayed 1084. The participant-user is now able to search leads captured by Column Header 1088 or search leads captured by Campaign Search Box 1086. Control is transferred to block 1090 where the system determines whether any leads captured information/report is found. If no leads captured information/report is found, then control is transferred to block 1098 and the system displays a search error message. If leads captured information/report is found, then control is transferred to block 1092 where a Leads Captured report is displayed. The participant-user then enters input and control is transferred to block 1094 where the system determines what action, if any, to take with regards to the Leads Captured report. If the decision is to take no action, then control is transferred to block 1099 and the participant-user is able to view the leads captured report on the Leads Captured page. If the participant-user chooses to take action, then control is transferred to block 1096 for the system to export the Leads Captured Report. From block 1096 control is transferred to block 1060 to export the data and the participant-user clicks or otherwise enters input into an Export Data Button 1060 and an Export Data Window Opens 1062 giving the participant-user the option to open or save the Leads Captured report file. The report generated through this process may be exported in various formats including CSV, Excel, text and other mode known to one of ordinary skill in the art or any other supported by the program/system of the invention.

FIG. 11 illustrates the process for navigating the “My Settings” menu of the participant-user dashboard. At block 1100 the “My Settings” page is displayed and at block 1102 the system waits for input from a participant-user to select one of the options in the “My Settings” submenu. The submenu options include Upgrade Package, My Profile, Store Settings, and Stickers and selection of any of these options depends on the participant-user's input. From block 1102 the participant-user clicks or otherwise enters input to the My Settings Menu 1105 and is able to further enter input to navigate to one of the submenu options in the My Settings Menu. Based on the participant-user's input, control may be transferred from block 1105 to block 1110 where the system determines whether to access the Upgrade Package submenu of the My Settings Menu. If yes, control is transferred to block 1112 where the participant-user is prompted to select the Upgrade Package submenu, resulting in an Upgrade Packages page being displayed 1114 and then the participant-user's current package displayed 1116. The participant-user then enters input and control is transferred to block 1118 where the system determines what action, if any to take. If the decision is to take no action, then control is transferred back to block 1105 where the participant-user is able to access one of the other submenu options in the My Settings menu.

As shown in FIG. 11, if the decision at block 1118 is take action, control is transferred to block 1120 where the system determines whether to upgrade the participant-user's current package. If the decision is no, then control is transferred to block 1122 where the system determines whether to upgrade by adding on a one or more particular features. If the participant-user chooses not to upgrade by adding on a feature, then control is transferred to block 1123 where the participant-user navigates back to block 1116. If the participant-user chooses to upgrade by adding on a feature, then control is transferred to block 1124 where the Upgrade Add-on page is displayed, and then the Add-on options are displayed 1126. The participant-user then selects an Add-on option and 1128 and pays 1130 the associated upgrade add-on charges. Similarly, at block 1120, if the participant-user chooses to update his current package, then control is transferred to block 1132 where he enters input and selects Upgrade Current Package. A Pricing page opens in a new window 1134 and the upgrade package options are displayed 1136. The participant-user selects a new package 1138 and pays the charges associated with the new package.

In FIG. 11, at block 1105 based on the participant-user's input, if the system determines not to access the Upgrade Package submenu of the My Settings Menu, control is transferred to block 1102 where the system waits for input. Upon receiving input, control is transferred to block 1105 where the participant-user clicks or otherwise enters input to access the My Profile submenu of the My Settings Menu. From block 1105 control is transferred to block 1140 where the system determines whether to access the My Profile submenu. If the decision is yes, then control is transferred to block 1142 where the participant-user selects the My Profile submenu and the My Profile page is displayed 1144. The participant-user then enters input and control is transferred to block 1146 where the system determines what action, if any to take. If the decision is to take no action, then control is transferred back to block 1105 where the participant-user is able to access one of the other submenu options in the My Settings menu.

As shown in FIG. 11, if the decision at block 1146 is take action, control is transferred to block 1148 where the participant-user is able to update his profile information, including uploading a logo to his profile. Control is transferred to block 1150 to upload files/logo and then to block 1152 where the system determines whether to submit the updated information, file, or logo. If the decision is no, then control is transferred to block 1158 for the system to reset and return to block 1146 in order to determine what action to take. If the decision at block 1152 is to submit the updated information, file, or logo, then control is transferred to block 1154 and the profile logo, file or updated information is stored 1156.

As illustrated in FIG. 11, if the decision at block 1146 is to take no action, then control is transferred back to block 1105 where the participant-user is able to access one of the other submenu options in the My Settings menu. At block 1105, based on the input entered by the participant-user, control may be transferred to block 1160 where the system determines whether to access the Store Settings submenu of the My Settings Menu. If the decision is yes, then control is transferred to block 1162 where the participant-user selects the Store Settings submenu and the Store Settings page is displayed 1164. The participant-user enters store information 1166 into the system, which may include location address, goods and or services provided, marketing and advertising goals, campaigns, pricing, or inventory list. Next the participant-user is prompted to enter the latitude and longitude coordinates for a particular store location 1168 into the system. Control is transferred to block 1170 where the system determines whether to submit the information entered for the particular store location. If the decision is no, then control is transferred to block 1176 to reset and return to block 1162 to enter new or revised store information. If the decision is to submit the information entered for the particular store location, control is transferred to block 1172 and the participant-user clicks or otherwise enters input to the Submit Button and the information is stored 1174.

In FIG. 11, if the decision at block 1160 is to not access the Store Settings submenu option of the My Settings Menu, then control is transferred to block 1180. At block 1180 based on the participant-user's input, control is transferred to block 1182 and the Stickers submenu of the My Settings Menu. The Sticker submenu allows the participant-user to create a sticker containing the URL or QR code for the program/system of the invention which may be affixed on any surface inside and outside of the participant-user's store location. This sticker allows consumers who enter the participant-user's store location to easily download via a web page or by scanning a QR Code program/system of the invention. By downloading the program/system of this invention, the consumer becomes linked to the same network as the participant-user and is able to access discounts, rewards, and loyalty points campaigns and advertisements generated by the participant through the program/system of the invention. The Stickers Page is displayed 1184 and the participant-user chooses to create a sticker with the program/system's URL or with a QR code which can be scanned. If the participant-user chooses not take no action, then control is transferred back to block 1102 where the system waits for input to navigate the My Settings Menu.

FIG. 11 illustrates the process for navigating the “My Offers” menu of the participant-user dashboard. At block 1200 the “My Offers” page is displayed and at block 1202 the system waits for input from a participant-user to select one of the options in the “My Offers” submenu. The submenu options include View Offers, Create Offers, and Offer Results and selection of any of these options depends on the participant-user's input. From block 1202 the participant-user clicks or otherwise enters input to the My Offers Menu 1204 and is able to further enter input to navigate to one of the submenu options in the My Offers Menu. Based on the participant-user's input, control may be transferred from block 1204 to block 1206 where the system determines whether to access the Create Offer submenu of the My Offers Menu. If yes, control is transferred to block 1208 where the participant-user is prompted to select the Create Offer submenu, resulting in a Create Offer page being displayed 1210 and then the participant-user is prompted to enter the terms and description of the offer being created 1212. The terms of the offer include, but are not limited to store location, offer name, offer type (e.g. discounts, rewards, loyalty points, and combinations thereof). The participant-user selects the offer category 1214 which may include, but is not limited to attractions, drink specials, health services, hotels, restaurants, shopping, museums, nightlife, professional services, salons and spas, special events, and sports and entertainment. The participant-user is able to further customize or add to existing categories according the marketing and advertising strategy for his products and/or services. The participant-user then selects the offer validity 1216 which are among the offer parameters required by the system. The offer validity input revolves around the duration and frequency for publishing the offer being created in the system. Control is then transferred to block 1218 where the system determines whether the offer will be valid for a single day. If the decision is to create a single day offer, then control is transferred to block 1220 where the participant-user selects the single day offer and the system the prompts him to enter the start and end date for the single day offer 1222. Control is then transferred to block 1224 and the system determines whether to set the time within the single day for which the offer is valid. If the participant-user chooses to set a time for the offer, then he is prompted to check the Set Offer Time box 1226 in the Set Single Offer pane. Once the Set Offer Time Box is checked, a start and end time box is displayed 1228 and the participant-user enters the start and end time 1230. Control is transferred to block 1234 where the participant-user clicks or otherwise enters input to the Generate Bar Code Link followed by clicking otherwise entering input to the Generate QR Code Link 1234. Control is then transferred to block 1238 where the system determines whether to submit the information entered for the new single day offer. If the participant-user chooses to submit the information entered for the new single day offer, then control is transferred to block 1240 where he clicks a submit button and system creates the new single day offer and stores the information. If the participant-user chooses not to submit the information entered for the new single day offer, then control is transferred to block 1242 where he clicks a cancel button and system does not store the information.

In FIG. 12, at block 1224 if the participant-user chooses not to set a time for a single day offer, the control is transferred to block 1232 and the Set Offer Time Box is unchecked. Control is transferred to block 1234 where the participant-user clicks or otherwise enters input to the Generate Bar Code Link followed by clicking or otherwise entering input to the Generate QR Code Link 1234. Control is then transferred to block 1238 where the system determines whether to submit the information entered for the new offer. If the participant-user chooses to submit the information entered for the new offer, then control is transferred to block 1240 where he clicks a submit button and system creates the new offer and stores the information. If the participant-user chooses not to submit the information entered for the new offer, then control is transferred to block 1242 where he clicks a Cancel Button and system does not store the information.

In FIG. 12, at block 1218 if the participant-user chooses not to create a single day offer, then control is transferred to block 1244 where the participant-user selects the recurring offer and a Set Recurring Offer Box is displayed 1246. Within the Set Recurring Offer Box, the participant-user selects the recurrence pattern for the offer (e.g. daily, weekly, monthly, seasonally, and the like) 1248 and then selects the date range for recurrence pattern of the offer 1250. Control is then transferred to block 1252 and the system determines whether to set a time within the recurring pattern and date range for which the offer is valid. If the participant-user chooses to set a time for the recurring offer, then he is prompted to check the Set Offer Time box 1254 in the Set Recurring Offer pane. Once the Set Offer Time Box is checked, a start and end time box is displayed 1256 and the participant-user enters the start and end time 1258. Control is transferred to block 1262 where the participant-user clicks or otherwise enters input to the Generate Bar Code Link followed by clicking otherwise entering input to the Generate QR Code Link 1264. Control is then transferred to block 1266 where the system determines whether to submit the information entered for the new recurring offer. If the participant-user chooses to submit the information entered for the new recurring offer, then control is transferred to block 1268 where he clicks a submit button and the system creates the new recurring offer and stores the information. If the participant-user chooses not to submit the information entered for the new recurring offer, then control is transferred to block 1270 where he clicks a cancel button and the system does not store the information.

In FIG. 12, at block 1204 if the participant-user choose to select the View Offers submenu instead of the Create Offers submenu, then control is transferred to block 1270 where the system determines whether to access the View Offers submenu of the My Offers Menu. If yes, control is transferred to block 1272 where the participant-user is prompted to select the View Offers submenu, resulting in a View Offer page being displayed 1274. Control is then transferred to block 1276 where the system determines whether to search for offers to view. If the decision is no, then control is transferred to block 1299 to access the Offer Results submenu of the My Offers Menu. However, if the decision is yes, the control is transferred to block 1278 to select the location of the offer from a drop down menu then enter an offer name in the Search Box 1280, click the Search Button 1282 and the search results are displayed 1284. Control is then transferred to block 1286 where the system determines what action, if any to take based on the search results. If the decision is to take no action, then control is transferred to block 1296 and the participant-user is able to view the offer search results. If the participant-user chooses to take action, then control is transferred to block 1288 for the system to export the offer search results. The participant-user clicks or otherwise enters input into an Export Data Button 1290 and an Export Data Window Opens 1292 giving the participant-user the option to open or save offer search results. The report generated through this process may be exported in various formats including CSV, Excel, text and other mode known to one of ordinary skill in the art or any other supported by the program/system of the invention.

In FIG. 12, at block 1270 if the participant-user chooses not to access the View Offers submenu, then control is transferred to block 1298 where the system determines whether to access the Offer Results submenu of the My Offers Menu. If yes, control is transferred to block 1299 where the participant-user is able to view offer results obtained and saved from an offer search completed in the View Offers submenu or from a Grab Offers Report generated in the Grab Offers submenu of the Reports menu as shown in FIG. 10.

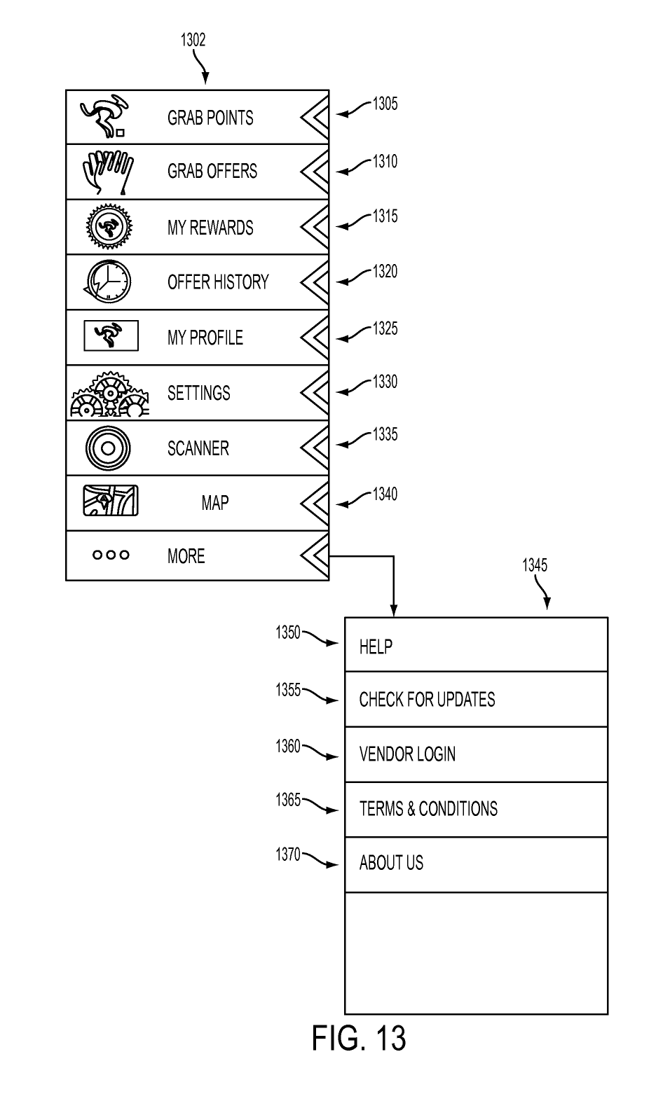

FIGS. 13, 14, and 15 relate to a mobile software application of the program/system of this invention. Although, the description of FIGS. 1-12 above focus on a computer web based application of the program/system of this invention, it is also applicable to the mobile and portable computer devices such as iPhones, smart phones, android, tablets, notepads, mini tablets and such similar portable computer devices known to one of ordinary skill in the art to which this invention belongs. This mobile software application is for use by both a participant-user and an End-User. FIG. 13 is a screen shot of the main page of the mobile software application as viewed on a mobile, digital or portable device. The Main Page 1302 comprises various tabs for accessing the variety of features of the program/system of this invention. The tabs include, but are not limited to Grab Points 1305, Grab Offers 1310, My Rewards 1315, Offer History 1320, My Profile 1325, Settings 1330, Scanner 1335, Map 1340, and More Options 1345. The More Options tab 1345 further comprises submenus including, but not limited to Help 1350, Check for Updates 1355, Vendor Login 1360, Terms and Conditions 1365, and About Us 1370.

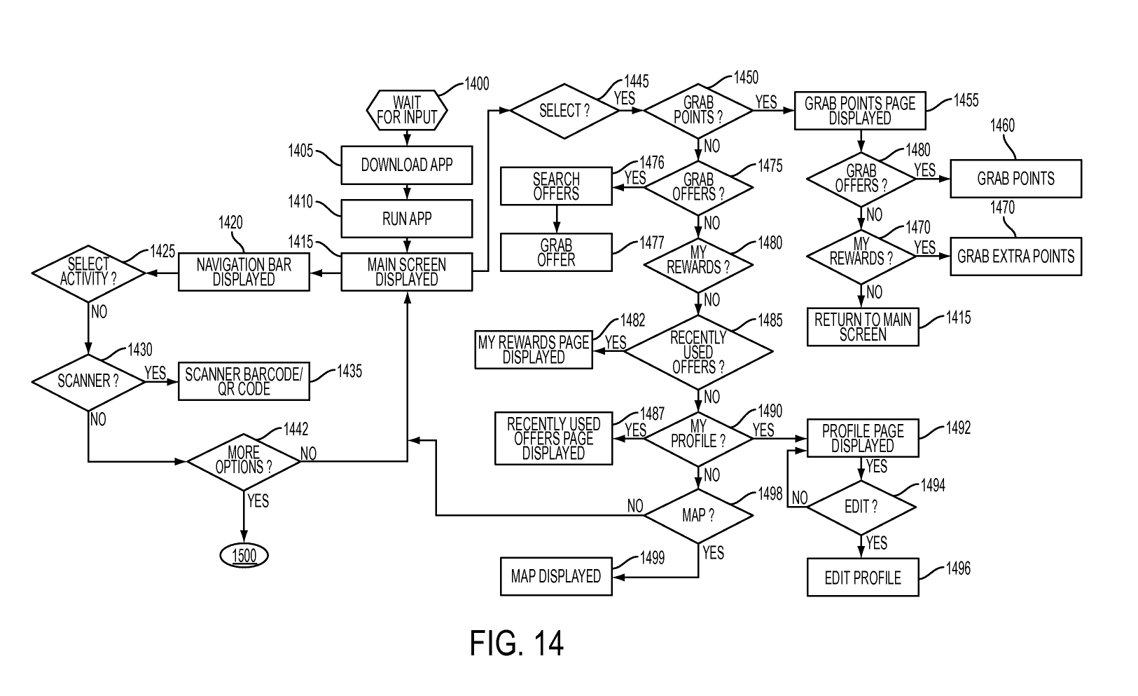

FIG. 14 is a logic flow diagram illustrating how an end-user accesses and navigates the mobile software application of the program/system of this invention. At block 1400 the system waits for input from an end-user. The end-user enters input and downloads the mobile software application of the program/system 1405 and runs the mobile software application of the program/system 1410. The Main Screen 1302 is displayed Control is transferred to block 1425 where the system determines whether to select an activity or tab from the Main Screen 1302. If the decision is to select and activity, control is transferred to the block 1450 where the system determines whether to access the Grab Points tab 1305. If the end-user decides to grab points then the Grab Points screen is displayed 1455 and the end-user determines whether to grab points or grab extra points. From block 1480 if the end-user decides to grab points, control is transferred to block 1460 where the end-user goes to a vendor location and grabs points. In order to grab extra points at block 1470, the end-user must first grab points at block 1460. In the event that an end-user determines to grab extra points before leaving a location, control is transferred to block 1470. If the end-user decides to leave the store without grabbing any points or without grabbing extra points, then control is transferred to block 1415 and the end-user may select another activity.

In FIG. 14, at block 1475 an end-user may choose to navigate to block 1475 to search for offers to grab at block 1477; or navigate to block 1480 to search for and view rewards accumulated at block 1482; or navigate to block 1485 to view offer history or recently used offers at block 1487; or navigate to block 1490 to view 1492 determine whether to edit 1494 or edit 1496 a profile. At block 1498 the end-user may determine whether to access the map tab of the mobile software application of the program/system. If yes, then the map is displayed 1499, but if no the end-user is re-directed to the main screen. This map tab is used to set-up and access the geographic parameter/geo-fencing coordinates for vendor store locations. An end-user is able to use the map to determine store locations and offers within his vicinity in real-time. Additionally, a vendor is able to set up offers that are linked to his store locations in real-time. Thus the internet based account and the mobile, digital, or portable computer device based accounts are updated and synced in real-time, giving the vendor the ability to adjust marketing campaigns and strategy in real time.

In FIG. 14, at block 1420 a navigation bar for transitioning between screens may be displayed on the Main Screen 1302. This navigation bar allows the users to access additional tabs that do not fit on the Main Screen 1302 or are later customized. In FIG. 13, a Scanner 1335 is included on the Main Screen, however it may be included on the navigation bar depending on the size and/or layout of the mobile, digital, or portable computer device. In FIG. 14, control is transferred to block 1425 where the system determines whether to select an activity to 1430 where determines whether to scan a bar code or QR Code and if yes control is transferred to block 1435. If not, then control is transferred to block 1440 to determine whether to navigate to More Options tab 1345. If yes then control is transferred to block 1500.

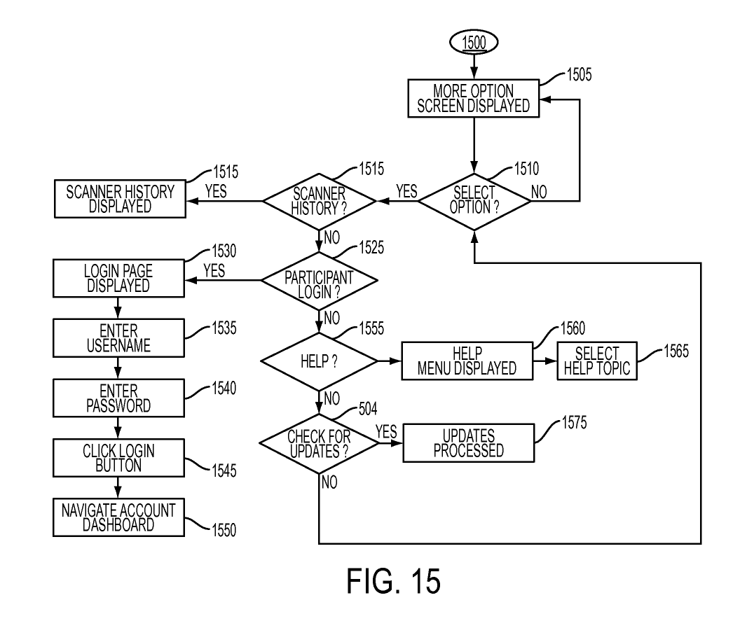

In FIG. 15, the More Options Screen is displayed 1505 and the system determines whether to select an option from the menu. If no then control transfers back to the More Options Screen at block 1505 and then back to the Main Screen to select another activity. Again, the More Options Screen includes tabs that were not displayed on the Main Screen such as Scanner History, Terms and Conditions, About Us, Help, Check for Updates and Vendor or Participant Login. The Vendor/Participant Login is utilized by Vendors who have already created a web based account in the program/system of the invention, but are able to manage and view their account seamlessly by logging into the mobile software application of the program/system. All the information viewed/accessed and activities carried out via mobile, digital, or portable computer device using the mobile software application of the program/system are in real-time.

Additionally, Vendors who have multiple locations with a large number of people who are accessing the program/system of the invention have the option to control and limit access to the system. The system provides and supports a super administrative function which allows the hierarchy of an enterprise to limit access to certain features of the system. For example higher level marketing and business executives may have access to all functions, including creating offers, generating QR Codes, and creating campaigns. Whereas lower level managers and employees in the location may only have access to changing the date and time for publishing a particular campaign or offer. This reduces overlap and the disorganization of marketing campaigns.

The program/system of the invention is also capable of integrating various payment methods including but not limited to sign up now-pay later, installment payment options, and similar methods of payment.

Before one can begin to navigate and use the mobile software application, the application must first be downloaded onto the mobile or portable computer device. The mobile software application may be downloaded via any available means such as the App Store, Android Market Place or Google Play, or App World. The mobile software application may also be downloaded from the website for the program/system of the invention which provides links to the App Store, Android platforms, App World and any other available platform for downloading applications for mobile or portable computer devices which incorporate or utilize a cloud based application sharing/syncing feature for computers and mobile/portable devices. Additionally, the website for the program/system of the invention in addition to allowing participant-users to login and set you their campaign and QR code marketing and advertising account/profile, allows all users to create an account and download the mobile application software of the program/system of the invention. An end-user is also able to download the mobile application software of the program/system of the invention by scanning or reading a bar code or QR Code sticker that is posted in and around a participant-user location. The creation of the Bar Code/QR Code stickers are further described in relation to FIG. 11 and the My Settings Menu of the participant-user dashboard. The mobile application software of the program/system of the invention includes and is downloaded in conjunction with a QR Code reader.

The general steps for downloading and using the mobile application software of the program/system of the invention using a mobile device, digital device or portable computer device include downloading the application; running the application; creating a username and password for setting up an account; logging into the application; using the application viewing, generating, and retrieving rewards, loyalty points, marketing campaigns all in real-time.

It is to be understood, that the subject invention described herein is not limited to the particular embodiments of the invention described herein, as variations of the particular embodiments may be made and still fall within the scope. It is also to be understood that the terminology employed is for the purpose of describing particular embodiments, and is not intended to be limiting.

### EQUIVALENTS

Those skilled in the art will recognize, or be able to ascertain using no more than routine experimentation, many equivalents to the specific embodiments of the invention described herein. Such equivalents are intended to be encompassed by the claims.

1. (canceled)

2. A method for using a computer system and a mobile device application to generate and manage offers, rewards, discounts, and loyalty points comprising:
a. Registering a vendor using the computer system or the mobile device application;
b. Registering a consumer using the computer system or the mobile device application;
c. Creating a digital representation of the vendor's location;
d. Identifying the consumer who enters the vendor location;
e. Awarding points to the consumer for entering the vendor location;
f. Awarding points to the consumer for time spent in the vendor location;
g. Identifying when the consumer leaves the vendor location;
h. Awarding points to the consumer upon leaving the vendor location;
i. Determining the amount of time the consumer spends in the vendor location.

3. A method as in claim 2 wherein the digital representation of the vendor's location is determined by manually entering the altitude, longitude and latitude coordinates of each point of a polygon that represents the shape of each floor of the vendor's location.

4. A method as in claim 2 wherein the digital representation of the vendor's location is determined by automatically entering the altitude, longitude and latitude coordinates of each point of a polygon that represents the shape of each floor of the vendor's location using the mobile device application with integrated GPS to automatically click each point within the polygon that represents the shape of the vendor's location and capturing the altitude, longitude and latitude coordinates of each point within the polygon.

5. A method as in claim 2 wherein the digital representation of the vendor's location is determined by placement of RFID technology in the vendor's location.

6. A method as in claim 2 wherein the digital representation of the vendor's location is determined by placement of blue tooth technology in the vendor's location.

7. A method for using a computer system and a mobile device application to generate and manage offers, rewards, discounts, and loyalty points in real time comprising:
a. Registering a vendor using the computer system or the mobile device application;
b. Registering a consumer using the computer system or the mobile device application;
c. Creating a digital representation of the vendor's location;
d. Identifying the consumer who enters the vendor location in;
e. Awarding points to the consumer for entering the vendor location;
f. Awarding points to the consumer for time spent in the vendor location in;
g. Identifying when the consumer leaves the vendor location;
h. Awarding points to the consumer upon leaving the vendor location;
i. Determining the amount of time the consumer spends in the vendor location.

8. A method as in claim 7 wherein the digital representation of the vendor's location is determined by manually entering the altitude, longitude and latitude coordinates of each point of a polygon that represents the shape of each floor of the vendor's location.

9. A method as in claim 7 wherein the digital representation of the vendor's location is determined by automatically entering the altitude, longitude and latitude coordinates of each point of a polygon that represents the shape of each floor of the vendor's location using the mobile device application with integrated GPS to automatically click each point within the polygon that represents the shape of the vendor's location and capturing the altitude, longitude and latitude coordinates of each point within the polygon.

10. A method as in claim 7 wherein the digital representation of the vendor's location is determined by placement of RFID technology in the vendor's location.

11. A method as in claim 7 wherein the digital representation of the vendor's location is determined by placement of blue tooth technology in the vendor's location.

12. A method for using a computer system and a mobile device application in combination with QR codes to generate offers and rewards comprising:
a. a vendor inputs information into the computer system or the mobile device application to generate a QR code;
b. the computer system or mobile device application saves and stores the QR code in the computer system or mobile device application;
c. the vendor displays the QR code on media;
d. a consumer scans the QR code with the mobile device application;
e. the consumer captures data stored on QR code using the mobile device application;
f. the consumer views information associated with QR code on the mobile device; and
g. using the mobile device application, the consumer optionally redeems the offer or reward associated with the QR code.

13. The method as in claim 12 wherein a vendor is able to receive and view consumer activity using a computer or mobile device application.

14. The method as in claim 12 wherein the vendor chooses criteria for generating offers, rewards, discounts, and loyalty points including date(s), time(s), duration(s), and frequency.

15. A method for processing payment for goods or services associated with an offer, reward, discount, or loyalty points using a computer system or mobile device application whereby a consumer is able to bypass a cashier or self-checkout station comprising;
accessing a micro payment system using a mobile device application designed to process the redemption of offers, rewards, and loyalty points;
selecting the option to process payment for goods or services associated with the offer, reward or points being redeemed;
selecting a payment option including credit card, paypal, EFT, layaway, deferred payment plan, or other electronic payment method; and
generating a receipt or confirmation of payment.

16. The method of claim 15 whereby a consumer at the vendor location has the option to ship the purchased item to a designated location.

17. The method of claim 15 whereby a consumer at a location outside of the vendor location has the option to ship the purchased item to a designated location.

18. The method of claim 15 whereby a consumer at the vendor location has the option to have the purchased item held at the vendor location to be picked up or shipped at a later date.

19. The method of claim 15 wherein a consumer at a location outside of the vendor location has the option to have the purchased item held at the vendor location to be picked up or shipped at a later date.

20. The method of claim 15 whereby the consumer at the vendor location has the option to defer payment of the selected item for a later date or make installment payments over a pre-determined period of time.

21. A system for linking offers, rewards and discounts among participating vendors using a computer system or mobile device application comprising:
a vendor submits names of other participating vendors for linking;
a participating vendor who receives a linking request, accepts or rejects linking;
the linked vendors share and honor customer offers, rewards, discounts or points.

22. A system for making charitable donations using a computer system or mobile device application for managing and generating offers, rewards, discounts and loyalty points comprising:
one or more charitable organizations register with an existing vendor rewards program;
a vendor selects a charitable organization from the list of registered charitable organizations for linking with the vendor's offers, rewards, discounts and loyalty points;
from existing offers, rewards, discounts, and loyalty points, the vendor assigns a charitable contribution to the specific charitable organization selected from the list of registered charitable organizations.

23. The method as in claim 22, wherein a vendor generates a new offer that assigns a charitable contribution to a charitable organization selected from the list of registered charitable organizations.
